(19) United States
(12) Patent Application Publication
(10) Pub. No.: US 2024/0394135 A1
(43) Pub. Date: Nov. 28, 2024

(54) LOG MANAGEMENT DEVICE, LOG MANAGEMENT METHOD, AND COMPUTER-READABLE RECORDING MEDIUM STORING LOG MANAGEMENT PROGRAM

(71) Applicant: Fujitsu Limited, Kawasaki-shi (JP)

(72) Inventor: Shuichi Nakagawa, Kawasaki (JP)

(73) Assignee: Fujitsu Limited, Kawasaki-shi (JP)

(21) Appl. No.: 18/656,801

(22) Filed: May 7, 2024

(30) Foreign Application Priority Data
May 23, 2023 (JP) 2023-084935

(51) Int. Cl. G06F 11/07

(52) U.S. Cl. CPC G06F 11/079; G06F 11/0709

(57) ABSTRACT

A log management device includes a memory, and a processor coupled to the memory and configured to obtain observation information group including observation information that includes a request ID same each other that identifies a series of processing executed in response to a request among pieces of observation information related to processing executed in each microservice, the pieces of the observation information being collected from each microservice of a plurality of the microservices, search the obtained observation information group for error information that indicates occurrence of an error and warning information that indicates occurrence of an event to be a cause of the error, and store at least partial information of the observation information group in a database that serves as a storage location according to a search result of the error information and the warning information.

### CROSS-REFERENCE TO RELATED APPLICATION

This application is based upon and claims the benefit of priority of the prior Japanese Patent Application No. 2023-84935, filed on May 23, 2023, the entire contents of which are incorporated herein by reference.

### FIELD

The embodiment discussed herein is related to a log management device, a log management method, and a log management program.

### BACKGROUND

Microservices have a software structure constituting one service by combining a plurality of software components that has been independently developed and runs. Observation information of the microservices may be collected to monitor running states of application programs of the microservices. For example, the observation information of the microservices is collected without stopping operation of a system, and is used for performance evaluation of the system.

As related art, there is a monitoring system in which an agent device sequentially obtains monitoring values from a processing unit and transmits the monitoring values after removal generated by removing noise from the monitoring values to a manager device, and the manager device refers to the monitoring values after removal obtained from the agent device and determines monitoring intervals at which the monitoring values are obtained from the agent device. Furthermore, there is a technique for managing notification related to execution of a microservice. Furthermore, there is a technique for managing a plurality of business devices that periodically distributes data using telemetry technology.

International Publication Pamphlet No. WO 2021/095114, U.S. Patent Application Publication No. 2022/0245017, and Japanese Laid-open Patent Publication No. 2020-28005 are disclosed as related art.

### SUMMARY

According to an aspect of the embodiments, a log management device includes a memory, and a processor coupled to the memory and configured to obtain observation information group including observation information that includes a request ID same each other that identifies a series of processing executed in response to a request among pieces of observation information related to processing executed in each microservice, the pieces of the observation information being collected from each microservice of a plurality of the microservices, search the obtained observation information group for error information that indicates occurrence of an error and warning information that indicates occurrence of an event to be a cause of the error, and store at least partial information of the observation information group in a database that serves as a storage location according to a search result of the error information and the warning information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a log management method according to an embodiment;

FIG. 2 is an explanatory diagram illustrating an exemplary system configuration of an information processing system 200;

FIG. 3 is a block diagram illustrating an exemplary hardware configuration of a log management server 201;

FIG. 4 is a block diagram illustrating an exemplary functional configuration of the log management server 201;

FIG. 5 is an explanatory diagram illustrating an exemplary operation of the information processing system 200;

FIG. 6 is an explanatory diagram illustrating a first exemplary operation of an application;

FIG. 7A is an explanatory diagram (part 1) illustrating a first exemplary sample of telemetry data;

FIG. 7B is an explanatory diagram (part 2) illustrating the first exemplary sample of the telemetry data;

FIG. 7C is an explanatory diagram (part 3) illustrating the first exemplary sample of the telemetry data;

FIG. 7D is an explanatory diagram (part 4) illustrating the first exemplary sample of the telemetry data;

FIG. 7E is an explanatory diagram (part 5) illustrating the first exemplary sample of the telemetry data;

FIG. 7F is an explanatory diagram (part 6) illustrating the first exemplary sample of the telemetry data;

FIG. 8A is an explanatory diagram (part 1) illustrating first exemplary creation of a formatted log;

FIG. 8B is an explanatory diagram (part 2) illustrating the first exemplary creation of the formatted log;

FIG. 9 is an explanatory diagram illustrating first exemplary storage of a structured log;

FIG. 10A is an explanatory diagram (part 1) illustrating second exemplary creation of the formatted log;

FIG. 10B is an explanatory diagram (part 2) illustrating the second exemplary creation of the formatted log;

FIG. 11 is an explanatory diagram illustrating second exemplary storage of the structured log;

FIG. 12 is an explanatory diagram illustrating a second exemplary operation of the application;

FIG. 13A is an explanatory diagram (part 1) illustrating a second exemplary sample of the telemetry data;

FIG. 13B is an explanatory diagram (part 2) illustrating the second exemplary sample of the telemetry data;

FIG. 13C is an explanatory diagram (part 3) illustrating the second exemplary sample of the telemetry data;

FIG. 14A is an explanatory diagram (part 1) illustrating third exemplary creation of the formatted log;

FIG. 14B is an explanatory diagram (part 2) illustrating the third exemplary creation of the formatted log;

FIG. 15 is an explanatory diagram illustrating third exemplary storage of the structured log;

FIG. 16 is an explanatory diagram illustrating a third exemplary operation of the application;

FIG. 17A is an explanatory diagram (part 1) illustrating a third exemplary sample of the telemetry data;

FIG. 17B is an explanatory diagram (part 2) illustrating the third exemplary sample of the telemetry data;

FIG. 17C is an explanatory diagram (part 3) illustrating the third exemplary sample of the telemetry data;

FIG. 18A is an explanatory diagram (part 1) illustrating fourth exemplary creation of the formatted log;

FIG. 18B is an explanatory diagram (part 2) illustrating the fourth exemplary creation of the formatted log;

FIG. 19 is an explanatory diagram illustrating fourth exemplary storage of the structured log;

FIG. 20 is a flowchart (part 1) illustrating an example of a log management processing procedure of the log management server 201;

FIG. 21 is a flowchart (part 2) illustrating an example of the log management processing procedure of the log management server 201;

FIG. 22 is a flowchart (part 1) illustrating an example of a specific processing procedure of a formatting process; and

FIG. 23 is a flowchart (part 2) illustrating an example of the specific processing procedure of the formatting process.

### DESCRIPTION OF EMBODIMENTS

In the related art, there is a problem that it is not possible to adjust a storage amount in a database that serves as a storage location of the observation information regarding the microservices collected for performance evaluation of the system or the like.

Hereinafter, an embodiment of techniques to enable adjustment of a storage amount in a database that serves as a storage location of observation information regarding microservices will be described in detail with reference to the drawings.

### Embodiment

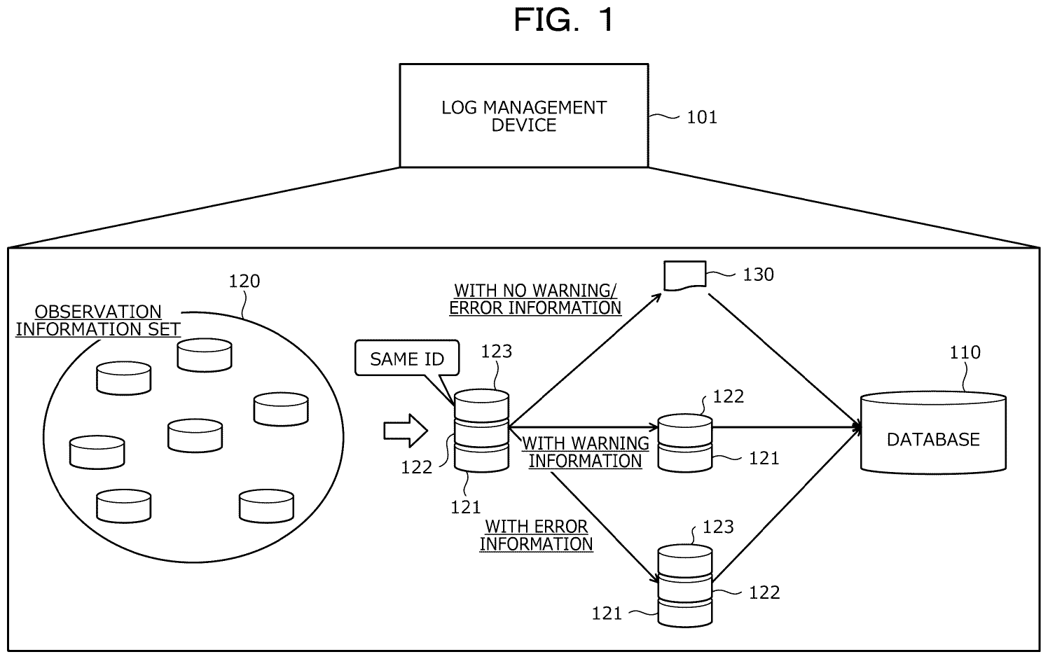

FIG. 1 is an explanatory diagram illustrating an example of a log management method according to an embodiment. In FIG. 1, a log management device 101 is a computer that adjusts a storage amount in a database 110 that serves as a storage location of observation information collected from each microservice of a plurality of microservices. The microservice is an architecture obtained by dividing one service for each function, or software that implements each function obtained by dividing one service.

By making the system into the microservices, it becomes possible to cope with a case where a function is added or a failure is corrected by replacing individual microservices, whereby improvement in correction speed and improvement in availability are expected without stopping the entire system. Each microservice is executed by, for example, a server different from each other. The server is, for example, a physical server or a virtual machine. Furthermore, the microservice may be executed by a container.

The plurality of microservices includes, for example, microservices having a call relationship. The plurality of microservices in the call relationship is a set of microservices for implementing the system, and a microservice included in the plurality of microservices implements a function while calling another microservice.

The observation information is information regarding processing executed in the microservice, and is for observing operations of the microservice. The observation information is also referred to as log information. The observation information includes observation information of a plurality of data types. Examples of the data type include an event, a metric, a log, a trace, and the like.

An event is a record of an individual request or action that has occurred at certain time. A metric is numerical information obtained by performing measurement, aggregation, or the like regarding execution of the microservice. A log is information (text data) generated by the system when an individual operation is executed in an application or a platform.

Furthermore, a trace is information indicating, when a request is processed across a plurality of services, transition regarding in what order the services are called. A message such as an error, a warning, or the like may be output together with the numerical information of the metric, or may be output as a log.

The system (service) including the plurality of microservices is a distributed service system for each microservice. Thus, it is important to appropriately manage each microservice and monitor it to operate efficiently. Furthermore, in order to incorporate logic for monitoring a state of a microservice into each microservice, a metric or a library is to be prepared for each distributed microservice, which is inefficient.

In view of the above, there is a case where observation information for monitoring a running state of each microservice (application program) is collected to carry out performance evaluation of the system or the like. Meanwhile, a microservice architecture deployed in the cloud has a configuration of being expandable using the plurality of microservices.

When the microservice architecture expands, a data amount of the observation information collected from the microservices increases accordingly, which leads to an increase in a memory area needed to store data. Furthermore, in order to secure the memory area needed to store data in the cloud, it is commonly charged according to the data amount to be collected and a transfer amount thereof.

There is an existing mechanism called a “service mesh” for appropriately managing communication between services linked in a form of a mesh so that management of distributed microservices does not fail in the system including the plurality of microservices. In the service mesh, a lightweight proxy associated with each microservice is provided to implement functions of managing service discovery, traffic control, observability, fault isolation, security, and the like.

The service discovery is a mechanism for identifying a location of a microservice to be called in a network. The traffic control is a mechanism for controlling communication between services by changing allocation of access to a microservice based on a setting or changing a return value from a microservice.

The observability is a mechanism for determining normality of a microservice by checking an internal state from data output from the microservice. The fault isolation is a mechanism for suppressing, when a failure occurs in an individual microservice, an influence range thereof to a minimum extent. The security is a mechanism for efficiently managing authentication/authorization and secure communication when a microservice calls another microservice.

Here, the service mesh includes two components of a control plane and a data plane, for example. The control plane handles management of the service mesh, stores information needed to manage the service discovery and the like, and issues management commands such as a configuration change and the like. The data plane controls service communication in response to an instruction from the control plane, and transmits information needed for management to the control plane.

For example, in the control plane, the observation information of each microservice may be collected from the data plane by the mechanism of the observability in the service mesh. For example, the control plane stores the observation information collected from each data plane in a database, and carries out performance evaluation of the system (improvement of the system and the application, identification of a failure point, etc.).

However, according to the related art, it is not possible to adjust a storage amount of the observation information collected for a microservice in a database. For example, a data amount of the observation information to be collected becomes an enormous data amount when density becomes higher (data types: large number, aggregation intervals: short) under various conditions, which largely consumes the database and storage.

On the other hand, when the density is set to be lower (data types: small number, aggregation intervals: long) to avoid high consumption of the database and the storage, a situation where data becomes insufficient occurs when a failure occurs or when improvement of the system or the application is carried out. According to the related art, it is not possible to determine what criterion is to be used to adjust the storage amount of the observation information in the database.

In view of the above, in the present embodiment, a log management method that enables adjustment of the storage amount in the database (e.g., database 110) that serves as a storage location of the observation information regarding the microservices will be described. Here, exemplary processes (corresponding to the following processes (1) to (3)) of the log management device 101 will be described.
(1) The log management device 101 obtains an observation information group including the same request ID among the observation information collected from each microservice of the plurality of microservices. The observation information is information regarding processing executed in each microservice. The request ID is an identifier for identifying a series of processing to be executed in response to a request.

The observation information includes the request ID for specifying connection of requests across the microservices. By continuously using the request ID in the entire series of processing, it becomes possible to extract the observation information regarding the series of processing from among an enormous number of pieces of collected observation information.

In the example of FIG. 1, an observation information set 120 is a set of the observation information collected from each microservice of the plurality of microservices. In this case, the log management device 101 obtains an observation information group including the same request ID from the observation information set 120. Here, a case where observation information groups 121 to 123 including the same request ID (“ID” in FIG. 1) are obtained is assumed.
(2) The log management device 101 searches the obtained observation information group for error information and warning information. Here, the error information is information indicating occurrence of an error. The warning information is information indicating occurrence of an event that may cause an error. Examples of the event that may cause an error include “long processing time”, “slow response”, “no certain information”, and the like.

The error information and the warning information may be included in the observation information. The error information in the observation information is specified by, for example, a character string such as “ERROR”, “error”, or the like. Furthermore, the warning information in the observation information is specified by, for example, a character string such as “WARN”, “warning”, or the like.
(3) The log management device 101 stores, in the database 110, some or all of the pieces of information of the observation information group depending on a search result of the search. The database 110 is a database that serves as a storage location of the observation information. The database 110 may be included in the log management device 101, or may be included in another computer accessible from the log management device 101.

Here, in a case where the error information and the warning information are not retrieved from the observation information group, it is a case where the system normally operates to complete the series of processing, and it may be said that the necessity to store the entire observation information group is low. Thus, for example, the log management device 101 reduces the storage amount in the database 110 by storing only predetermined partial information in the observation information group.

The partial information includes, for example, information (event) regarding processing that serves as a starting point of an operation in response to a request, and the request ID. Furthermore, the partial information may include information indicating transition of the microservice that has operated in response to the request. Furthermore, the partial information may include information regarding metrics and a status code when the operation in response to the request is terminated.

Furthermore, in a case where no error information is retrieved and the warning information is retrieved from the observation information group, it is a case where the event that may cause an error has occurred while there is no error in the series of processing. In this case, it is better to analyze the event to determine whether or not further investigation is needed.

Thus, for example, the log management device 101 may store, in the database 110, only the observation information of the same data type as the observation information including the warning information in the observation information group. It may be said that the observation information of the same data type as the observation information including the warning information is useful information for analyzing the event that may cause an error.

Furthermore, the log management device 101 may store, in the database 110, only the observation information including the warning information in the observation information group. As a result, the log management device 101 reduces the storage amount in the database 110 as compared with the case of storing the entire observation information group. However, the log management device 101 may store the entire observation information group in the database 110 when the warning information is retrieved.

Furthermore, in a case where error information is retrieved from the observation information group, it is a case where some error has occurred in the series of processing, and it may be said that it is a situation that needs to be handled by identifying the failure point and investigating a cause. Thus, for example, the log management device 101 stores the entire observation information group in the database 110.

In the example of FIG. 1, first, it is assumed that the error information and the warning information are not retrieved from the observation information groups 121 to 123. In this case, for example, the log management device 101 extracts predetermined partial information 130 from the observation information groups 121 to 123. Then, the log management device 101 may store, in the database 110, only the extracted partial information 130 for the observation information groups 121 to 123.

Furthermore, it is assumed that no error information is retrieved and the warning information is retrieved from the observation information groups 121 to 123. In this case, for example, the log management device 101 extracts the observation information including the warning information from the observation information groups 121 to 123. Here, it is assumed that observation information 121 and 122 including the warning information is extracted. In this case, the log management device 101 may store, in the database 110, the extracted observation information 121 and 122 for the observation information groups 121 to 123. At this time, the log management device 101 may store, in the database 110, the extracted observation information 121 and 122 together with the partial information 130.

Furthermore, it is assumed that the error information is retrieved from the observation information groups 121 to 123. In this case, for example, the log management device 101 may store the observation information groups 121 to 123 in the database 110. At this time, the log management device 101 may store, in the database 110, the observation information groups 121 to 123 together with the partial information 130.

As described above, according to the log management device 101, it becomes possible to adjust the storage amount in the database 110 that serves as a storage location of the observation information regarding the microservices. For example, the log management device 101 may adjust, in units of the observation information group associated with the same request ID, whether to store only partial information or the entire information of the observation information group depending on whether or not the error information or the warning information is included. Thus, the log management device 101 may reduce the storage capacity to be used to store the observation information in the database 110 while retaining information useful for performance evaluation of the system and the like.

### [Exemplary System Configuration of Information Processing System 200]

Next, an exemplary system configuration of an information processing system 200 including the log management device 101 illustrated in FIG. 1 will be described. Here, a case will be taken as an example and described where the log management device 101 illustrated in FIG. 1 is applied to a log management server 201 in the information processing system 200. The information processing system 200 is applied to, for example, a computer system that provides a web service using a microservice architecture.

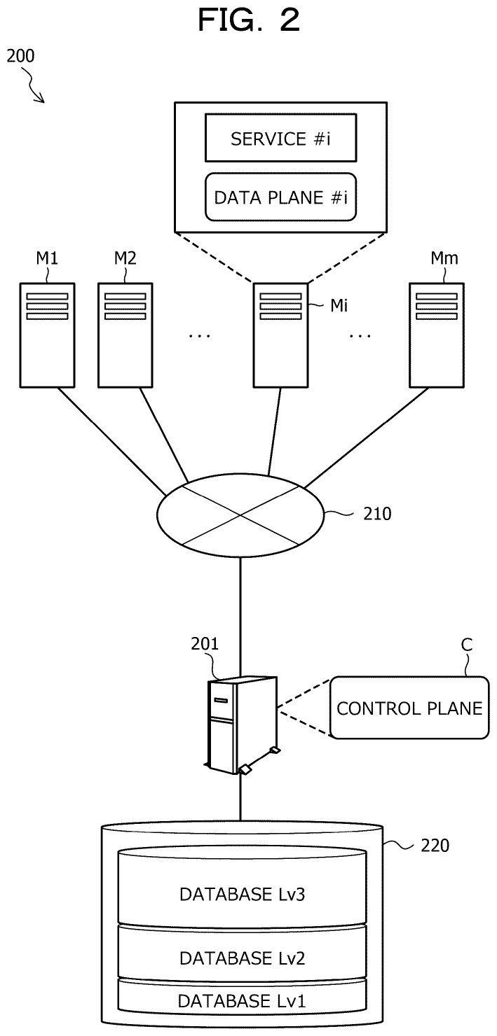

FIG. 2 is an explanatory diagram illustrating an exemplary system configuration of the information processing system 200. In FIG. 2, the information processing system 200 includes the log management server 201 and processing devices M1 to Mm (m: natural number of 2 or more). In the information processing system 200, the log management server 201 and the processing devices M1 to Mm are coupled via a wired or wireless network 210. Examples of the network 210 include the Internet, a local area network (LAN), a wide area network (WAN), and the like.

Here, the log management server 201 is a computer that adjusts a storage amount of telemetry data in a database 220. The database 220 is a database that serves as a storage location of the telemetry data. The telemetry data corresponds to the observation information output from each microservice of the plurality of microservices.

The database 220 includes a database Lv1, a database Lv2, and a database Lv3. The database Lv1, the database Lv2, and the database Lv3 correspond to different divided storage areas (first storage area, second storage area, and third storage area) in the database 220. The database 110 illustrated in FIG. 1 corresponds to the database 220, for example.

Here, a case where the log management server 201 includes the database 220 will be described. However, the database 220 may be included in another computer (e.g., database server) accessible from the log management server 201.

Furthermore, the log management server 201 includes a control plane C. The control plane C is one of components included in the service mesh, and handles management of the service mesh. The control plane C stores information needed to manage the microservices coupled by the service mesh, and issues management commands such as a configuration change and the like. For example, the control plane C controls communication related to the service by transmitting a management instruction to a data plane, thereby managing the microservice.

The processing devices M1 to Mm are computers capable of executing each microservice of the plurality of microservices. A microservice is a software component that runs independently. A plurality of software components is mutually coupled and combined to constitute one service (application, system).

For example, each of the processing devices M1 to Mm may start a container in its own device to execute a microservice in the container. For example, the processing devices M1 to Mm may be physical servers, or may be virtual machines that operate in the physical servers.

Furthermore, the processing devices M1 to Mm are capable of executing a data plane. The data plane is one of the components included in the service mesh, which controls communication of the microservices in response to an instruction from the control plane C, and transmits information needed for management to the control plane.

In the following descriptions, any one processing device of the processing devices M1 to Mm may be referred to as a “processing device Mi” (i=1, 2, . . . , m). Furthermore, a microservice executed in the processing device Mi may be referred to as a “service #i”. Furthermore, a data plane that operates in the processing device Mi may be referred to as a “data plane #i”. For example, a microservice executed in the processing device M1 is a “service #1”, and a data plane that operates in the processing device M1 is a “data plane #1”. Furthermore, a microservice executed in the processing device Mm is a “service #m”, and a data plane that operates in the processing device Mm is a “data plane #m”.

In the information processing system 200, the data plane #i obtains telemetry data related to the service #i. At this time, the data plane #i adds, to the telemetry data, the request ID for identifying the series of processing to be executed in response to the request. Then, the data plane #i transmits the obtained telemetry data (including the request ID) to the control plane C.

The transmission of the telemetry data by the data plane #i is periodically performed at predetermined time intervals, for example. For example, the data plane #i obtains telemetry data in response to execution of the service #i. Then, each time a certain period of time elapses, the data plane #i collectively transmits the telemetry data obtained in that period to the control plane C. However, the data plane #i may transmit the obtained telemetry data to the control plane C each time the telemetry data related to the service #i is obtained.

Although illustration is omitted, the information processing system 200 includes a user terminal to be used by a user of the information processing system 200. Examples of the user terminal include, for example, a personal computer (PC), a tablet PC, and the like. Furthermore, the information processing system 200 may include a database, a camera, a robot, a sensor, and the like to be accessed from the service #i. For example, the service #i accesses the database to read and write data, and accesses the sensor to obtain sensor data.

### [Exemplary Hardware Configuration of Log Management Server 201]

Next, an exemplary hardware configuration of the log management server 201 will be described.

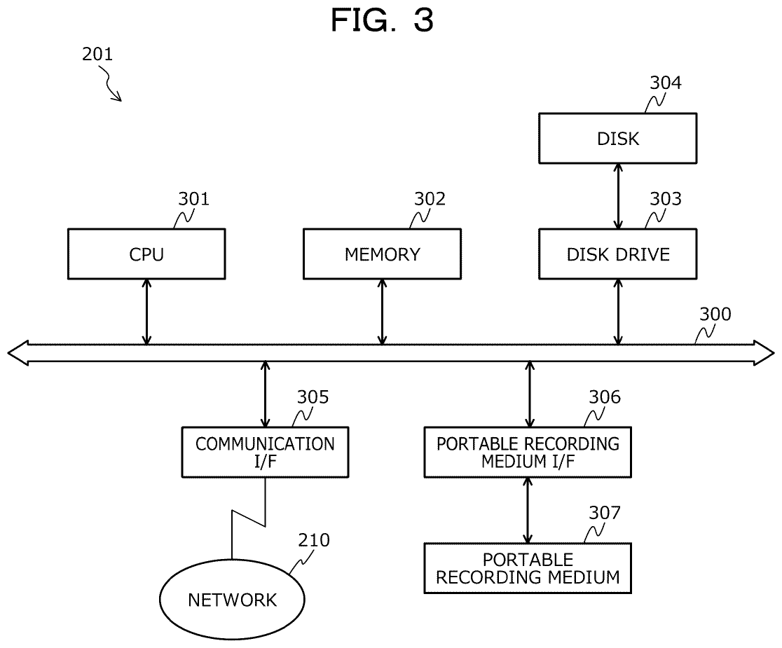

FIG. 3 is a block diagram illustrating an exemplary hardware configuration of the log management server 201. In FIG. 3, the log management server 201 includes a central processing unit (CPU) 301, a memory 302, a disk drive 303, a disk 304, a communication interface (I/F) 305, a portable recording medium I/F 306, and a portable recording medium 307. Furthermore, the individual components are coupled to each other by a bus 300.

Here, the CPU 301 takes overall control of the log management server 201. The CPU 301 may include a plurality of cores. The memory 302 includes, for example, a read only memory (ROM), a random access memory (RAM), a flash ROM, and the like. For example, the flash ROM stores operating system (OS) programs, the ROM stores application programs, and the RAM is used as a work area for the CPU 301. The programs stored in the memory 302 are loaded into the CPU 301 to cause the CPU 301 to execute coded processing.

The disk drive 303 controls reading/writing of data from/to the disk 304 under the control of the CPU 301. The disk 304 stores data written under the control of the disk drive 303. Examples of the disk 304 include a magnetic disk, an optical disk, and the like. The database 220 illustrated in FIG. 2 is implemented by, for example, a storage device such as the memory 302, the disk 304, or the like.

The communication I/F 305 is coupled to the network 210 through a communication line, and is coupled to an external computer (e.g., processing devices M1 to Mm illustrated in FIG. 2) via the network 210. Then, the communication I/F 305 controls an interface between the network 210 and the inside of the device, and controls input/output of data to/from the external computer. Examples of the communication I/F 305 include a modem, a LAN adapter, and the like.

The portable recording medium I/F 306 controls reading/writing of data from/to the portable recording medium 307 under the control of the CPU 301. The portable recording medium 307 stores data written under the control of the portable recording medium I/F 306. Examples of the portable recording medium 307 include a compact disc (CD)-ROM, a digital versatile disk (DVD), a universal serial bus (USB) memory, and the like.

Note that the log management server 201 may include, for example, an input device, a display, and the like in addition to the components described above. Furthermore, the log management server 201 may not include, for example, the portable recording medium I/F 306 and the portable recording medium 307 among the components described above. Furthermore, the processing devices M1 to Mm illustrated in FIG. 2 may also be implemented by a hardware configuration similar to that of the log management server 201.

### [Exemplary Functional Configuration of Log Management Server 201]

Next, an exemplary functional configuration of the log management server 201 will be described.

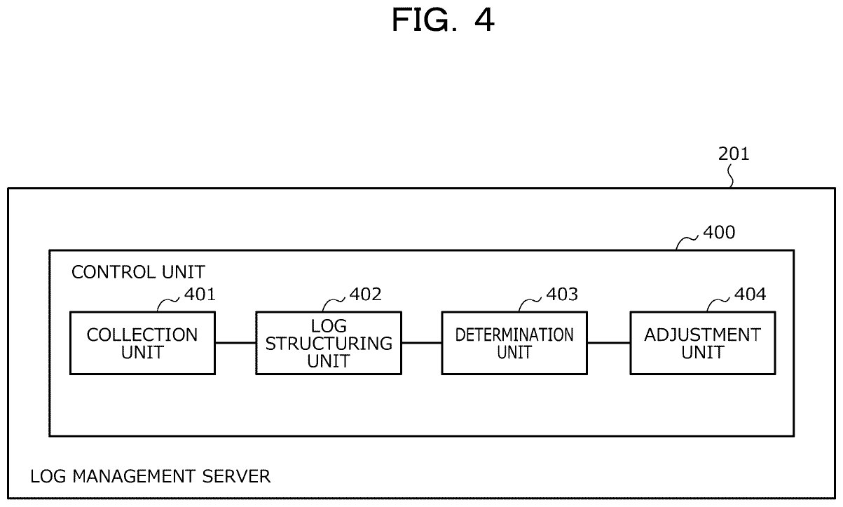

FIG. 4 is a block diagram illustrating an exemplary functional configuration of the log management server 201. In FIG. 4, the log management server 201 includes a collection unit 401, a log structuring unit 402, a determination unit 403, and an adjustment unit 404. The collection units 401 to the adjustment units 404 have functions that serve as a control unit 400, and for example, those functions are implemented by causing the CPU 301 to execute programs stored in a storage device such as the memory 302, the disk 304, the portable recording medium 307, or the like illustrated in FIG. 3 or by the communication I/F 305. A processing result of each of the functional units is stored in, for example, a storage device such as the memory 302, the disk 304, or the like. For example, each of the functional units (collection unit 401 to adjustment unit 404) is implemented by the control plane C illustrated in FIG. 2.

The collection unit 401 collects telemetry data from each service #i. Here, the telemetry data is information regarding processing executed in the service #i, and is for observing operations of the service #i. The telemetry data is used for, for example, checking of normality of a system or an application, analysis and improvement of performance, and the like.

The telemetry data includes telemetry data of a plurality of data types. A data type is determined based on, for example, from what viewpoint the operations of the service #i are observed. Examples of the data type include an event, a metric, a log, and a trace.

An event is a record of an individual request or action that has occurred at certain time. An event indicates, for example, information indicating that the service #i has executed processing, the service #i has received an instruction, or the like together with time information. An event is used for analysis of what operation or matter has triggered occurrence of a problem, and the like.

A metric is numerical information obtained by performing measurement, aggregation, or the like regarding execution of the service #i in the processing device Mi. A metric is obtained by measuring a total, an average, or the like within a certain period of time, such as a usage rate of a CPU, a memory, a disk, or the like, or the number of requests per unit second. A metric is used for analysis of behavior of the service #i per unit time, periodic behavior of the service #i, and the like.

A log is information generated by the system when an individual operation is executed in an application or a platform. A log corresponds to a detailed record of an operation that has occurred at a specific time. A text message such as an error, a warning, or the like may be output as a log. A log is used for analysis of a detailed situation, such as in which line of the program an error has occurred at a time of occurrence of a failure or the like, and a type of the error at that time, and the like.

A trace is information indicating, when a request is processed across a plurality of services, transition regarding in what order the services are called. A trace is a mechanism for understanding the order in which services are called, a status of processing of each service, and the like. A trace is used for, for example, identifying a problematic point in complicatedly cooperating services.

For example, the collection unit 401 collects the telemetry data related to each service #i by receiving the telemetry data transmitted from the data plane #i of each processing device Mi. The collected telemetry data is temporarily stored in, for example, a buffer pool provided in the memory 302.

The log structuring unit 402 structures the collected telemetry data (log information). The structuring is to create a structured log by collecting the telemetry data having the same request ID. First, the log structuring unit 402 obtains a telemetry data group including the same request ID among the collected telemetry data. Then, the log structuring unit 402 creates a structured log for the obtained telemetry data group.

For example, the log structuring unit 402 refers to the data type of each piece of the obtained telemetry data group, and extracts predetermined partial information from the telemetry data group, thereby creating formatted log information including the extracted partial information.

The predetermined partial information includes, for example, information regarding processing that serves as a starting point of an operation in response to a request, which is extracted from the telemetry data of the events, and the request ID. Examples of the information regarding the processing that serves as a starting point of the operation include a time stamp, a message, a method, and the like. The request ID is a request ID commonly included in each of the telemetry data groups.

Furthermore, the partial information may include, for example, information indicating transition of microservices that have operated in response to a request (which services have been called in what order), which is extracted from the telemetry data of the logs traces. Furthermore, the partial information may include, for example, metrics data (numerical information) when an operation in response to a request is terminated (completed), which is extracted from the telemetry data of the metrics.

Furthermore, the partial information may include, for example, a status code when an operation in response to a request is terminated (completed), which is extracted from the telemetry data of the metrics. The status code is, for example, a status code of a hypertext transfer protocol (HTTP).

Furthermore, the partial information may include, for example, information input in processing executed in response to a request (any processing of the series of processing identified by the request ID), which is extracted from the telemetry data of the logs. Furthermore, the partial information may include, for example, information regarding the operation of the microservice that has transitioned last, which is extracted from the telemetry data of the logs.

Furthermore, the log structuring unit 402 searches the obtained telemetry data group for error information and warning information. Here, the error information is information indicating occurrence of an error. The warning information is information indicating occurrence of an event that may cause an error. Examples of the event that may cause an error include “long processing time”, “slow response”, and the like.

The error information and the warning information are included in, for example, the telemetry data with the data type of the metric or log. The error information in the telemetry data is specified by, for example, a character string such as “ERROR” or the like. The warning information in the telemetry data is specified by, for example, a character string such as “WARN” or the like.

The error information includes, for example, a method, a function, a file name, and the like in which an error has occurred. Furthermore, the error information may include, for example, a time stamp, a message, stack trace information, and the like when an error occurs. Furthermore, the error information may include, for example, information indicating a microservice in which an error has occurred.

The warning information includes, for example, a method, a function, a file name, and the like in which an event that may cause an error has occurred. Furthermore, the warning information may include, for example, a time stamp, a message (suspicion message), and the like when an event that may cause an error occurs. Furthermore, the warning information may include, for example, information indicating a microservice in which an event that may cause an error has occurred.

Furthermore, the log structuring unit 402 creates formatted log information including the extracted partial information. The formatted log information is unique information among pieces of telemetry data having the same request ID. In the following descriptions, the formatted log information may be referred to as a “formatted log”.

Furthermore, in a case where the error information is retrieved from the telemetry data group, the log structuring unit 402 may add the retrieved error information to the formatted log. Furthermore, in a case where the warning information is retrieved from the telemetry data group, the log structuring unit 402 may add the retrieved warning information to the formatted log.

Then, the log structuring unit 402 sets the telemetry data group and the formatted log in combination as a structured log.

The determination unit 403 refers to the formatted log included in the structured log, and determines a level of the structured log according to a predefined assessment method. Then, the determination unit 403 sets the determined level in the structured log. Here, the level of the structured log is used at a time of adjusting the storage amount of the telemetry data group included in the structured log in the database 220.

For example, the determination unit 403 determines whether or not the error information and the warning information are included in the formatted log. Here, in a case where neither the error information nor the warning information is included in the formatted log, the determination unit 403 determines that the level of the structured log is “Lv1”.

Furthermore, in a case where the formatted log includes no error information and includes the warning information, the determination unit 403 determines that the level of the structured log is “Lv2”. Furthermore, in a case where the error information is included in the formatted log, the determination unit 403 determines that the level of the structured log is “Lv3”.

For example, the determination unit 403 may sort the levels of the structured log into Lv2 and Lv3 depending on whether or not an event that exerts influence between traces has occurred. The event that exerts influence between traces is not an event that affects only one microservice, but is an event that also affects another linked microservice so that a series of processing for a request is incomplete.

Occurrence of the event that exerts influence between traces is determined based on, for example, the error information or the warning information. It is possible to optionally set a type of the error information or warning information for determining that the event that exerts influence between traces has occurred.

For example, in a case where at least one piece of error information is included in the formatted log, the determination unit 403 may determine that the event that exerts influence between traces has occurred. Furthermore, in a case where specific error information is included in the formatted log, the determination unit 403 may determine that the event that exerts influence between traces has occurred. Furthermore, in a case where specific warning information is included in the formatted log, the determination unit 403 may determine that the event that exerts influence between traces has occurred.

Furthermore, even in the case where the error information or the warning information is included in the formatted log, the determination unit 403 may determine that no event that exerts influence between traces has occurred when an operation for a request (operation for a series of processing in response to the request) is normally complete. For example, whether or not the operation for the request is normally complete may be determined based on the status code of the HTTP.

For example, in a case where it is determined that no event that exerts influence between traces has occurred with reference to the formatted log, the determination unit 403 determines that the level of the structured log is “Lv2”. On the other hand, in a case where it is determined that the event that exerts influence between traces has occurred, the determination unit 403 determines that the level of the structured log is “Lv3”. Then, the determination unit 403 adds the determined level to the formatted log included in the structured log.

The adjustment unit 404 adjusts the storage amount in the database 220 that serves as a storage location of the telemetry data group. For example, the adjustment unit 404 stores, in the database 220, some or all of the pieces of information of the telemetry data group according to the level of the structured log.

For example, the adjustment unit 404 processes the telemetry data group included in the structured log according to the level of the structured log. The level (e.g., Lv1, Lv2, or Lv3) of the structured log is specified from, for example, the formatted log included in the structured log.

For example, in a case where the level in the formatted log is “Lv1”, the adjustment unit 404 deletes the telemetry data group from the structured log. Then, the adjustment unit 404 stores the structured log from which the telemetry data group has been deleted in the database Lv1 in the database 220. For example, “Lv1” corresponds to a case where the error information and the warning information are not retrieved from the telemetry data group. In this case, only the formatted log is stored in the database Lv1 for the telemetry data group.

Furthermore, in a case where the level in the formatted log is “Lv2”, the adjustment unit 404 may extract the telemetry data of a specific data type from the telemetry data group included in the structured log. The specific data type is, for example, the same data type as the telemetry data including the warning information in the formatted log.

It is assumed that the data type of the telemetry data including the warning information is the “metric”. In this case, the adjustment unit 404 specifies the telemetry data with the data type of the “metric” from the telemetry data group. Furthermore, the specific data type may be, for example, the same data type as the telemetry data including the error information in the formatted log.

Next, the adjustment unit 404 deletes the telemetry data other than the specified telemetry data in the telemetry data group included in the structured log. Then, the adjustment unit 404 stores, in the database Lv2 in the database 220, the structured log from which the telemetry data other than the specified telemetry data has been deleted.

For example, “Lv2” corresponds to a case where no error information is retrieved and the warning information is retrieved from the telemetry data group. In this case, for the telemetry data group, the specified telemetry data is stored in the database Lv2 together with the formatted log. The formatted log includes, for example, the warning information.

Furthermore, in a case where the level in the formatted log is “Lv3”, the adjustment unit 404 stores the structured log in the database Lv3 in the database 220. For example, “Lv3” corresponds to a case where the error information is retrieved from the telemetry data group. In this case, for the telemetry data group, the entire telemetry data group is stored in the database Lv3 together with the formatted log.

The formatted log includes, for example, the error information. However, in the case where the level in the formatted log is “Lv3”, the adjustment unit 404 may not include the error information in the formatted log. Since the entire telemetry data group is stored in the case where the level in the formatted log is “Lv3”, the error information may be checked from the telemetry data group.

Note that the telemetry data temporarily stored in the buffer pool in the memory 302 is deleted when, for example, the structured log for the telemetry data is stored in the database 220. Furthermore, while the case where the level of the structured log is determined to be “Lv2” in the case where no error information is included and the warning information is included in the formatted log and the level of the structured log is determined to be “Lv3” in the case where the error information is included in the formatted log has been exemplified in the descriptions above, it is not limited to this. For example, the determination unit 403 may determine that the level of the structured log is “Lv3” in a case where at least one of the error information or the warning information is included in the formatted log.

### [Exemplary Operation of Information Processing System 200]

Next, an exemplary operation of the information processing system 200 will be described.

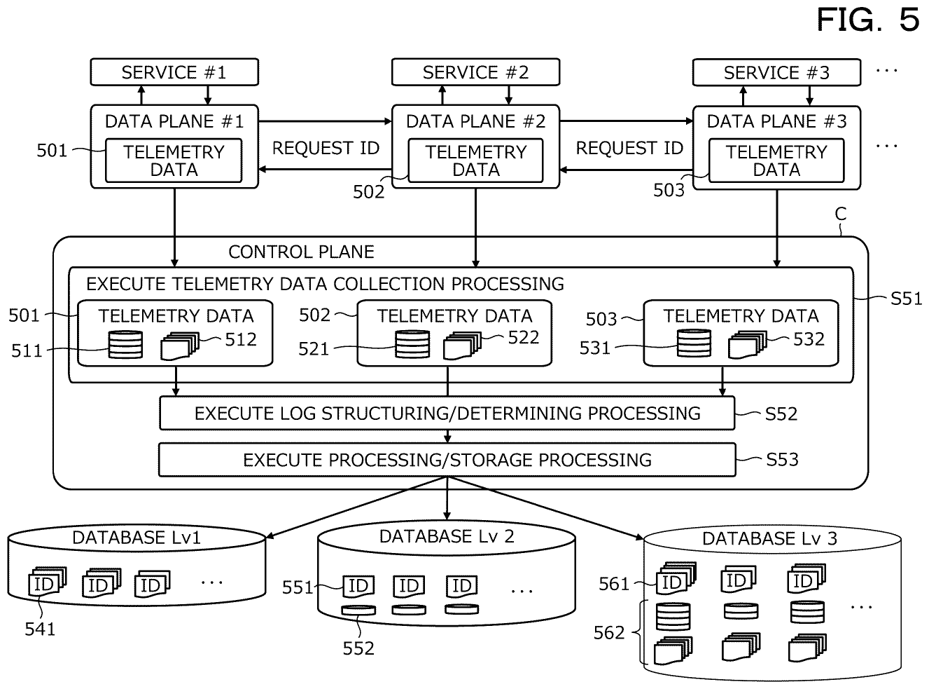

FIG. 5 is an explanatory diagram illustrating an exemplary operation of the information processing system 200. FIG. 5 illustrates the control plane C that operates in the log management server 201, and services #1 to #3 and data planes #1 to #3 that operate in processing devices M1 to M3. The services #1 to #3 are microservices having a call relationship.

First, the control plane C executes telemetry data collection processing S51. The telemetry data collection processing S51 is processing of collecting the telemetry data related to the individual services #1 to #3. The telemetry data is, for example, telemetry data for a certain period of time collected by the individual data planes #1 to #3.

Here, the telemetry data with the data type of the “metric” may be referred to as “metrics data”, and the telemetry data with the data type of the “event, log, or trace other than the metric” may be simply referred to as “logs”.

For example, the control plane C collects telemetry data 501 from the data plane #1. The telemetry data 501 includes metrics data 511 and logs 512 related to the service #1. Furthermore, the control plane C collects telemetry data 502 from the data plane #2. The telemetry data 502 includes metrics data 521 and logs 522.

Furthermore, the control plane C collects telemetry data 503 from the data plane #3. The telemetry data 503 includes metrics data 531 and logs 532. Here, it is assumed that the telemetry data groups 501 to 503 are telemetry data groups including the same request ID.

Next, the control plane C executes log structuring/determining processing S52. The log structuring/determining processing S52 is processing of creating a structured log from the telemetry data groups 501 to 503 and determining a level of the created structured log according to a predefined assessment method.

Then, the control plane C executes processing/storage processing S53. The processing/storage processing S53 is processing of adjusting the storage amount in the database 220 by processing the telemetry data group included in the structured log according to the level of the structured log.

For example, in a case where the level of the structured log is “Lv1”, the control plane C deletes the telemetry data group from the structured log, and stores it in the database Lv1 in the database 220. In this case, only the formatted log (e.g., formatted log 541) in the structured log is stored in the database Lv1.

Furthermore, in a case where the level of the structured log is “Lv2”, the control plane C deletes the telemetry data of a data type other than a specific data type in the telemetry data group in the structured log, and stores it in the database Lv2 in the database 220. Here, it is assumed that the specific data type is the “metric”. In this case, the formatted log and the metrics data (e.g., formatted log 551 and metrics data 552) in the structured log are stored in the database Lv2.

Furthermore, in a case where the level of the structured log is “Lv3”, the control plane C directly stores the structured log in the database Lv3 in the database 220. In this case, the formatted log and the telemetry data group (e.g., formatted log 561 and telemetry data group 562) in the structured log are stored in the database Lv3.

### [Exemplary Level Determination and Exemplary DB Storage of Structured Log]

Next, exemplary level determination and exemplary database (DB) storage of the structured log will be described. However, in the following descriptions, exemplary service configurations and data samples are simplified for explaining the operation of the example.

### Case 1: Exemplary Level Determination and Exemplary DB Storage of Structured Log

First, exemplary level determination and exemplary DB storage of the structured log in Case 1 will be described.

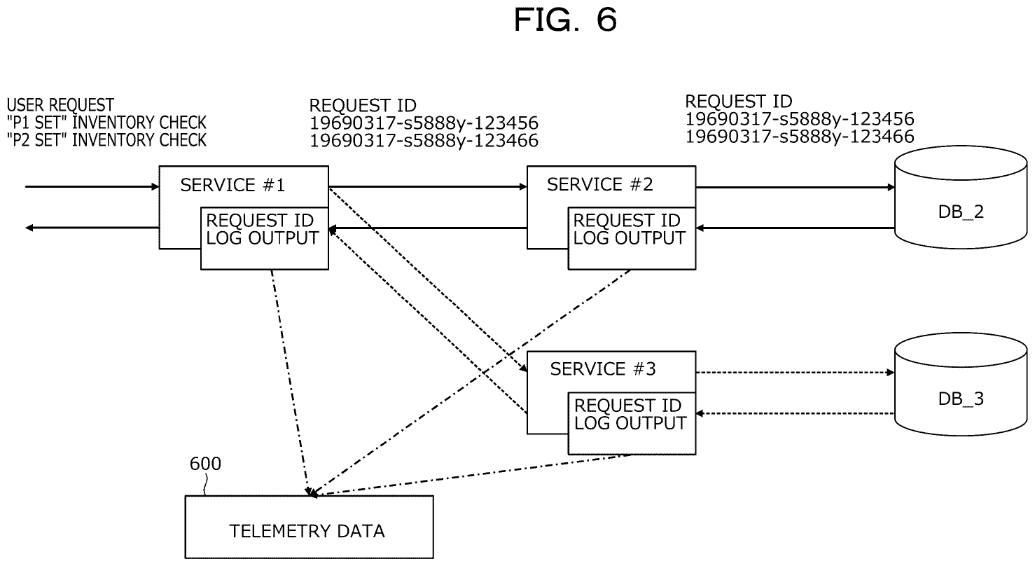

FIG. 6 is an explanatory diagram illustrating a first exemplary operation of an application. FIG. 6 illustrates the service #1 that processes a request from the user and the services #2 and #3 that execute an operation requested from the service #1 as microservices for implementing a certain application (service). Databases DB_2 and DB_3, which store information, are coupled to the services #2 and #3.

As an example, it is assumed that the operation of the application is a process of checking inventory information in an inventory database corresponding to a requested keyword and returning information to the user in response to a request (inventory check) from the user. In Case 1, it is assumed that inventory checks of “P1 SET” and “P2 SET” are received from the user.

In Case 1, the service #1 calls the service #2 to check the inventory information of “P1 SET” and “P2 SET”. Information (telemetry data) logged for each of the services #1 to #3 is collected in one location (control plane C) as telemetry data 600.

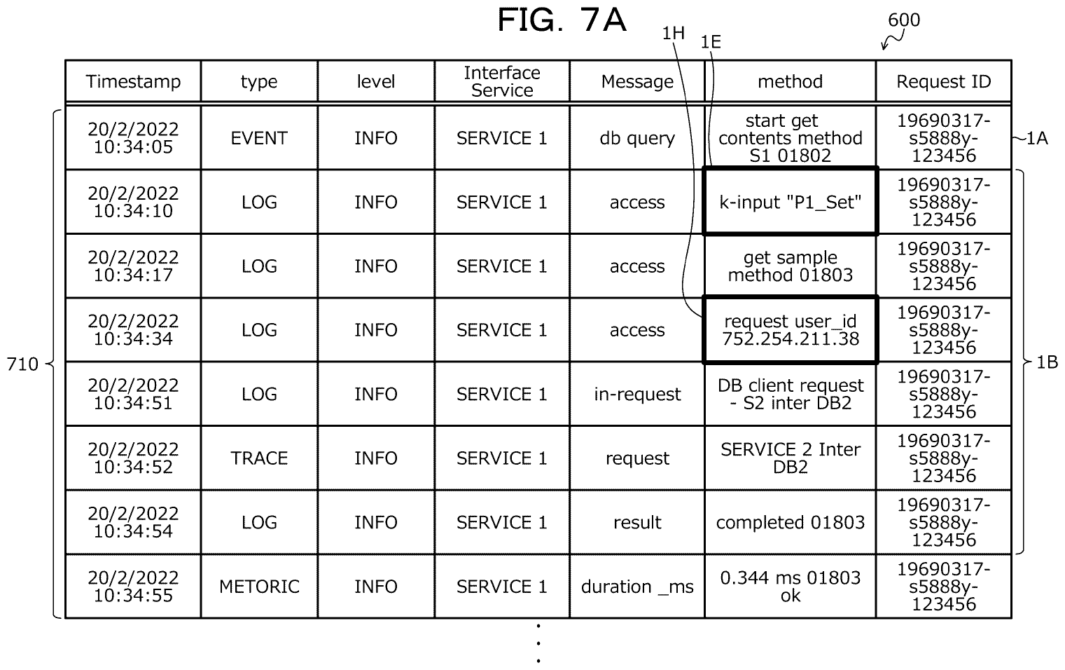

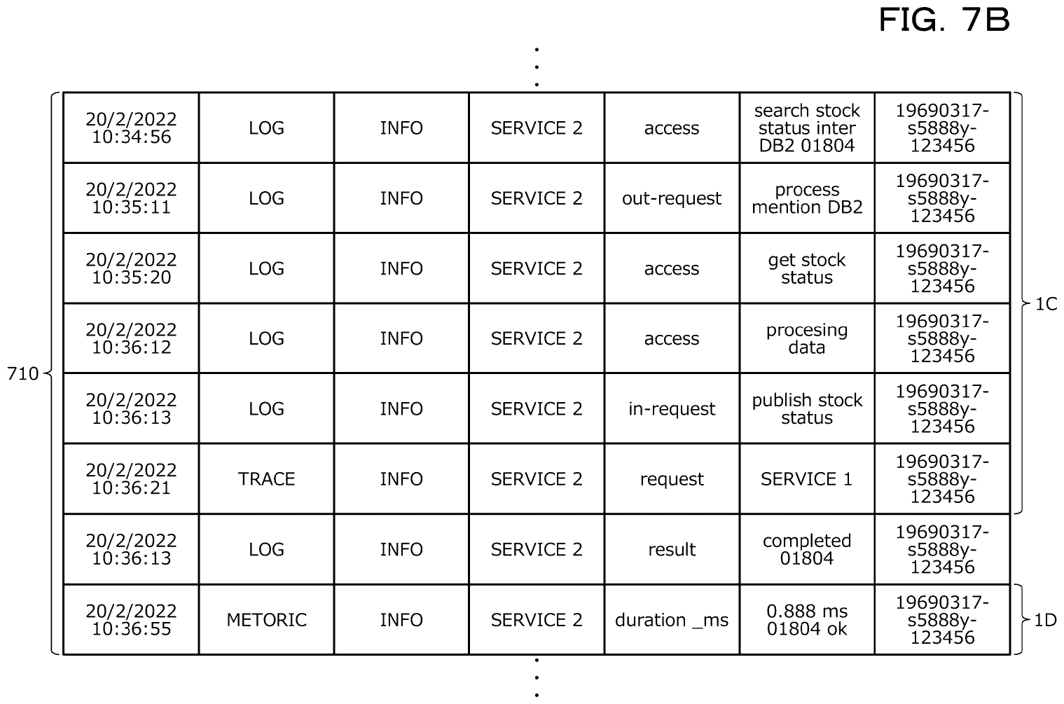

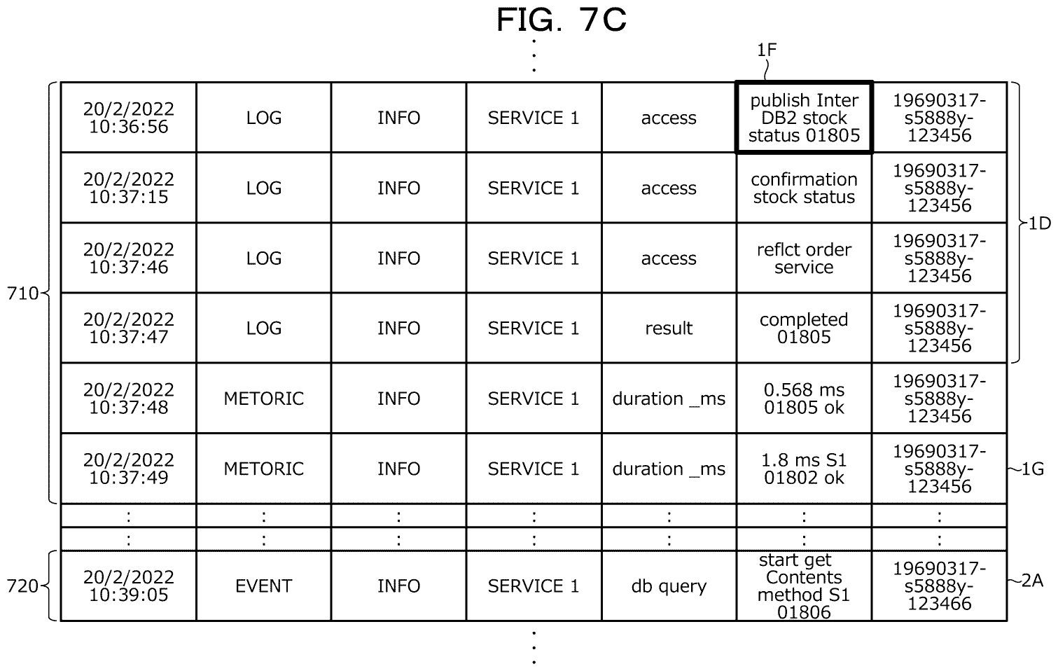

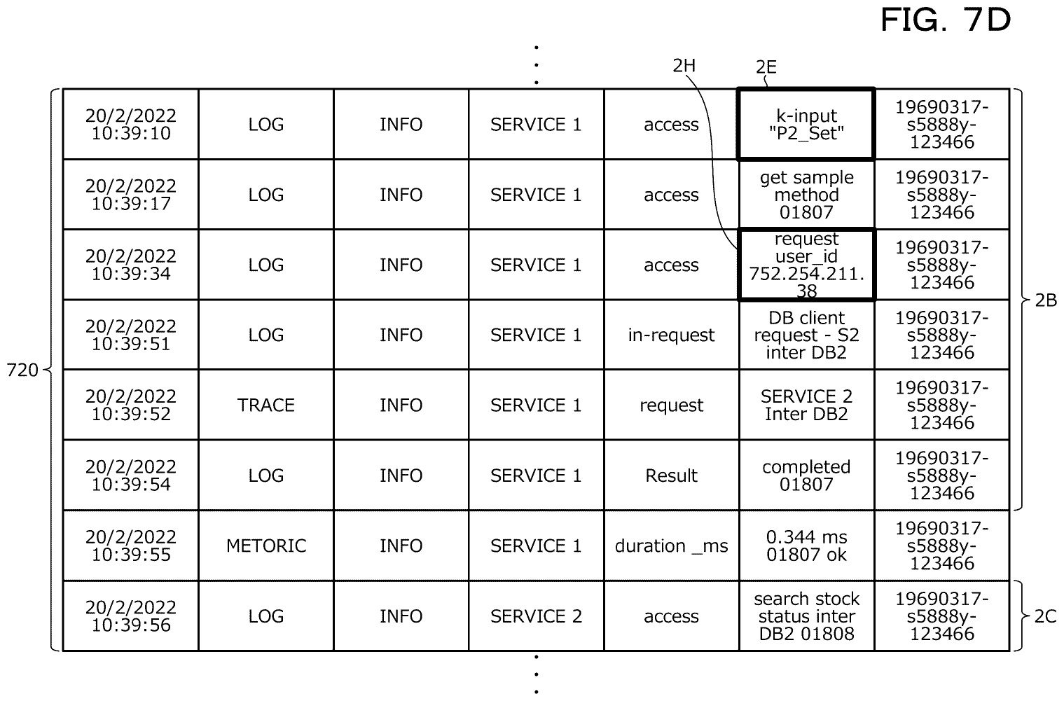

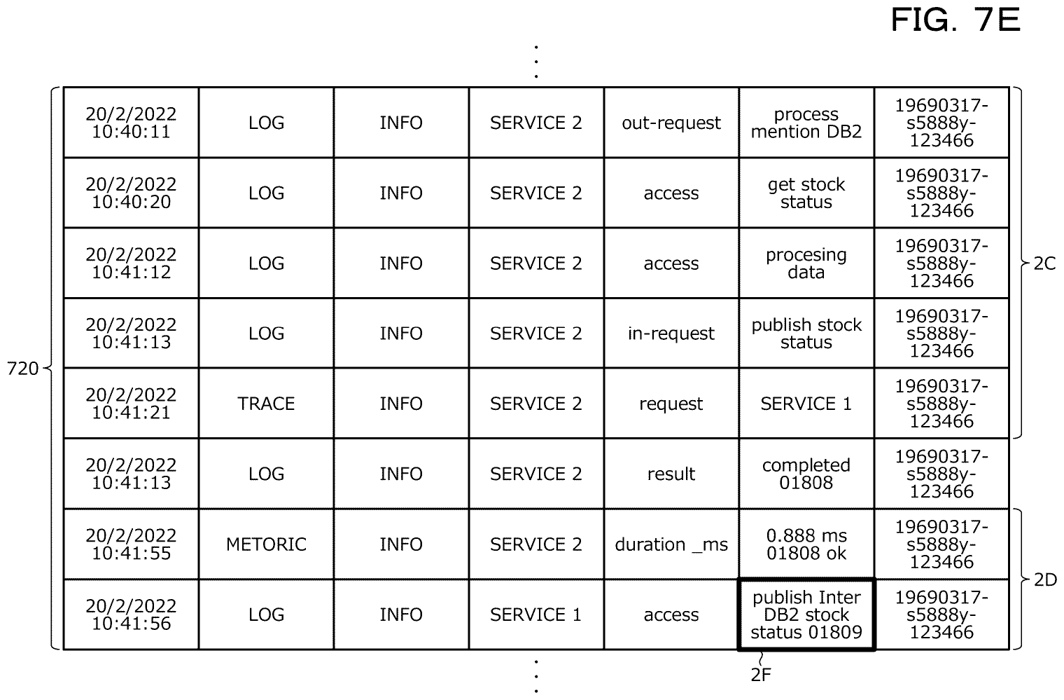

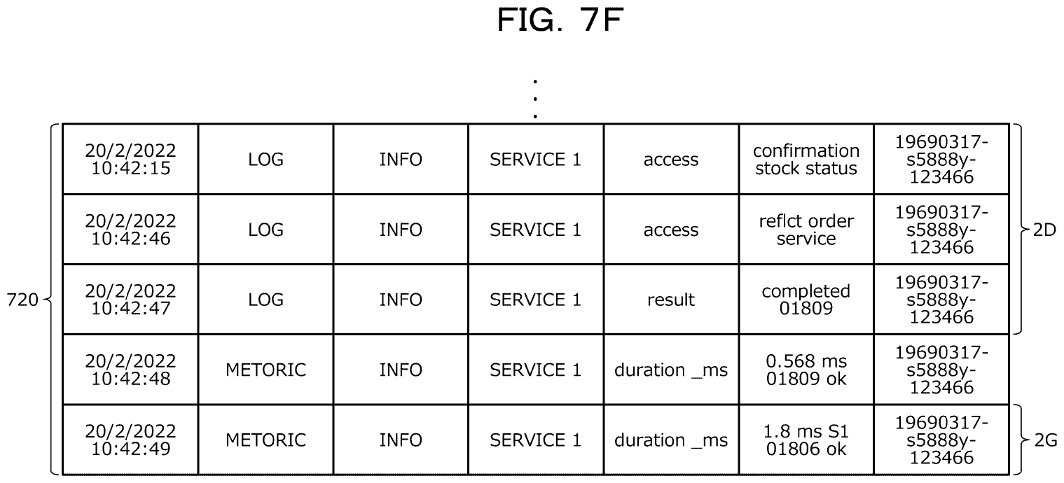

Next, the telemetry data 600 will be described with reference to FIGS. 7A to 7F.

FIGS. 7A to 7F are explanatory diagrams illustrating a first exemplary sample of the telemetry data. In FIGS. 7A to 7F, the telemetry data 600 is a set of telemetry data. For example, each piece of the telemetry data is sporadically issued from each service #i, and is collected in one location (control plane C illustrated in FIG. 2) as the telemetry data 600.

Each piece of the telemetry data is text data including information regarding individual items of a timestamp, type, level, interface service, message, method, and request ID. The timestamp indicates a date and time when each piece of the telemetry data is recorded (issued) or processing corresponding to each piece of the telemetry data is executed in each service #i.

The type indicates a data type (EVENT, METRIC, LOG, or TRACE) of each piece of the telemetry data. EVENT corresponds to an event. METRIC corresponds to a metric. LOG corresponds to a log. TRACE corresponds to a trace. The level indicates a level (log level) of each piece of the telemetry data. Examples of the level of each piece of the telemetry data include INFO, WARN, and ERROR.

INFO indicates provision of information. WARN indicates a warning of a potential problem or the like. ERROR indicates an error such as a serious failure or the like. The interface service indicates a service of an issuer of each piece of the telemetry data. The message indicates a message issued by the service #i. The method indicates a method executed by the service #i. The request ID is a request ID included in each piece of the telemetry data.

The telemetry data 600 is obtained by arranging the telemetry data (log information) related to the request for the inventory check of “P1 SET” and “P2 SET” in time series for each request ID. A telemetry data group 710 with the request ID “19690317-s5888y-123456” is telemetry data regarding the inventory check of “P1 SET”. Furthermore, a telemetry data group 720 with the request ID “19690317-s5888y-123466” is telemetry data regarding the inventory check of “P2 SET”.

The control plane C obtains a telemetry data group including the same request ID from the telemetry data 600. Next, the control plane C creates a formatted log from the obtained telemetry data group.

Here, exemplary creation of the formatted log will be described focusing on the telemetry data group 710 including the request ID “19690317-s5888y-123456”.

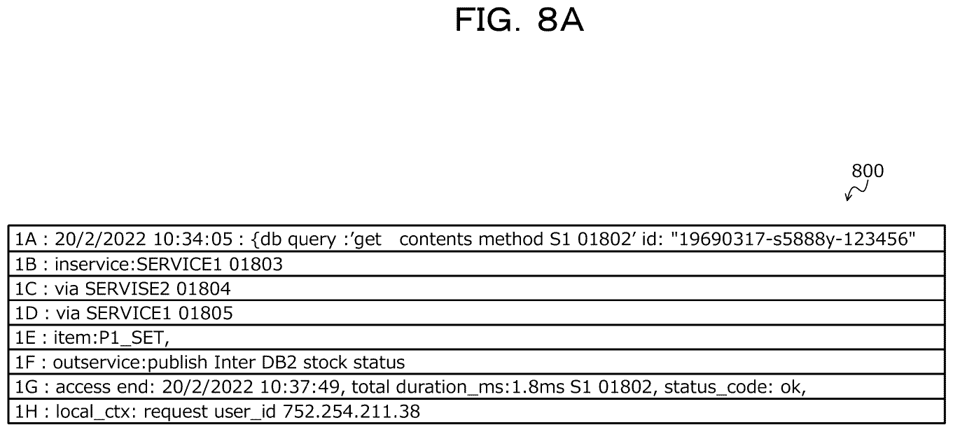

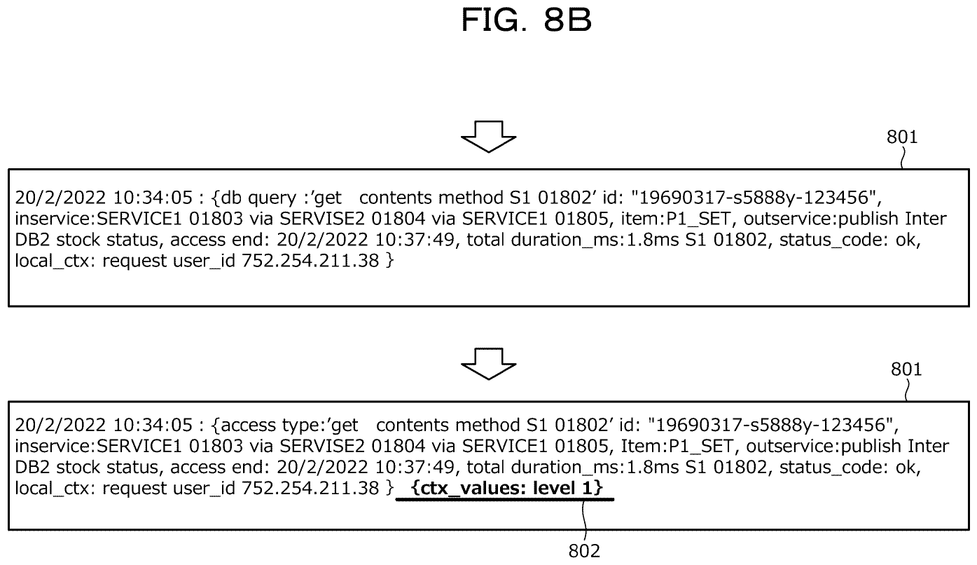

FIGS. 8A and 8B are explanatory diagrams illustrating first exemplary creation of the formatted log. In FIG. 8A, the control plane C creates, from the telemetry data group 710, a context 800 to be in a form of a unique log format for the user request of the inventory check of “P1 SET”. The context 800 corresponds to contents of the formatted log.

First, the control plane C extracts information regarding the processing that serves as a starting point of the operation in response to the request from the telemetry data of the type “EVENT” of the telemetry data group 710. Here, the time stamp “get contents method (inventory check)” of “db query” and the request ID “19690317-s5888y-123456” are extracted from the method of the type “EVENT” (1A).

Next, the control plane C extracts information indicating transition of the service #i that has operated in response to the request from the telemetry data of the type “LOG, TRACE” of the telemetry data group 710. Here, information indicating transition of the operated microservices “SERVICE1, SERVICE2, SERVICE1” is extracted (1B), (1C), and (1D). SERVICE1 corresponds to the service #1. SERVICE2 corresponds to the service #2.

Next, the control plane C extracts input information from the telemetry data of the type “LOG” of the telemetry data group 710. Here, “P1 SET” is extracted (1E). Next, the control plane C extracts information regarding the operation of the service #i that has transitioned last from the telemetry data of the type “LOG” of the telemetry data group 710. Here, information regarding the operation of “01805” is extracted (1F).

Next, the control plane C extracts information when the operation in response to the request is terminated (completed) from the telemetry data of the type “METRIC” of the telemetry data group 710. Here, information regarding the time stamp of the completion flag of the operation, the metric data (total duration), and the status code is extracted (1G).

Furthermore, the control plane C extracts, as other information, the ID of the request user from the telemetry data of the type “LOG” of the telemetry data group 710. Here, “request user_id 752.254.211.38” is extracted (1H).

Furthermore, the control plane C searches the telemetry data group 710 for the error information and the warning information. The error information is specified from the level “ERROR”, for example. The warning information is specified from the level “WARN”, for example. Here, the error information and the warning information are not retrieved from the telemetry data group 710.

In FIG. 8B, the control plane C creates a formatted log 801 from the context 800. The control plane C sets the telemetry data group 710 and the formatted log 801 in combination as a structured log (referred to as “structured log LG1” here).

Next, the control plane C refers to the formatted log 801 and determines a level of the structured log LG1 according to a predefined assessment method. Here, the level “Lv1” is set in a case where neither the error information nor the warning information is included in the formatted log 801. Furthermore, in a case where only the warning information is included in the formatted log 801, it is determined that no event that exerts influence between traces has occurred, and the level “Lv2” is set. Furthermore, in a case where the error information is included in the formatted log 801, it is determined that the event that exerts influence between traces has occurred, and the level “Lv3” is set.

The formatted log 801 includes neither the error information nor the warning information. Thus, the control plane C determines that the level of the structured log LG1 is “Lv1”. Then, the control plane C sets the determined level “Lv1” in the formatted log 801 (portion of the reference sign 802 in FIG. 8B).

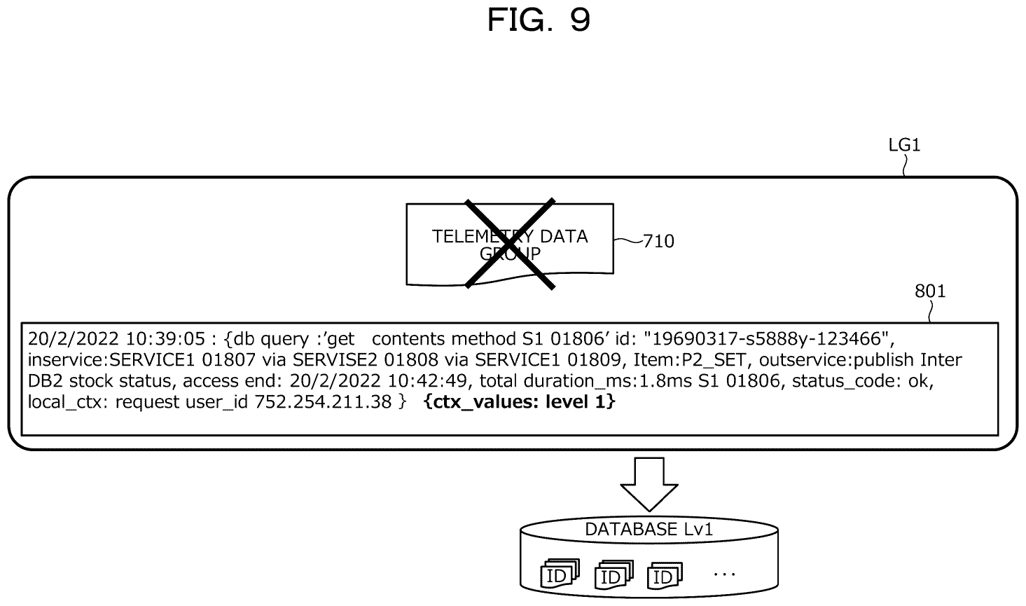

Next, exemplary storage of the structured log LG1 will be described with reference to FIG. 9.

FIG. 9 is an explanatory diagram illustrating first exemplary storage of the structured log. In FIG. 9, the control plane C adjusts the storage amount of the telemetry data group 710 in the structured log LG1 in the database 220. For example, the control plane C processes the telemetry data group 710 included in the structured log LG1 according to the level in the formatted log 801.

Here, since the level in the formatted log 801 is “Lv1”, the control plane C deletes the telemetry data group 710 from the structured log LG1. Then, the control plane C stores the structured log LG1 from which the telemetry data group 710 has been deleted in the database Lv1 in the database 220.

Next, exemplary creation of the formatted log will be described focusing on the telemetry data group 720 including the request ID “19690317-s5888y-123466”.

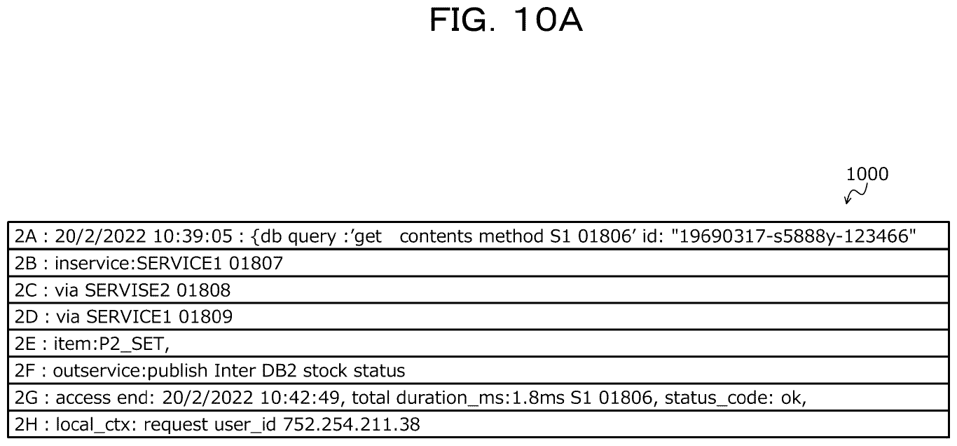

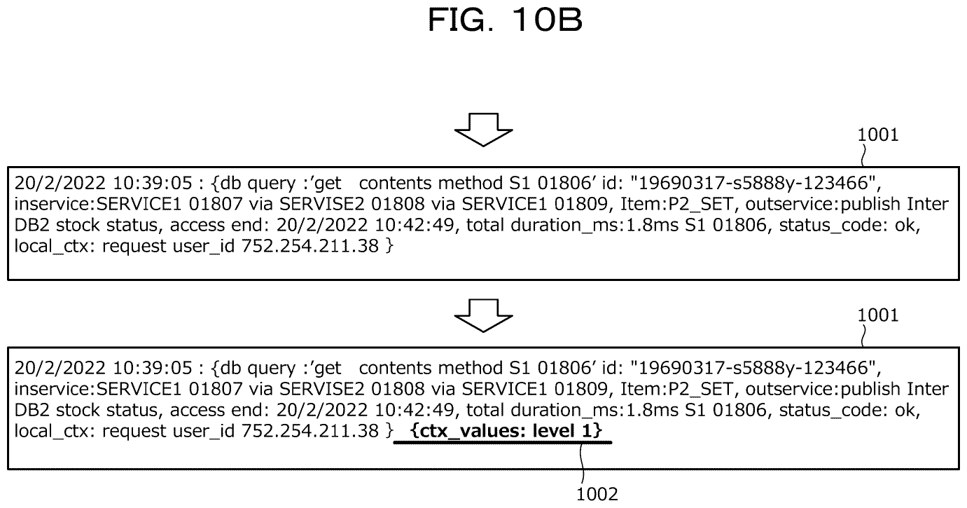

FIGS. 10A and 10B are explanatory diagrams illustrating second exemplary creation of the formatted log. In FIG. 10A, the control plane C creates, from the telemetry data group 720, a context 1000 to be in a form of a unique log format for the user request of the inventory check of “P2 SET”. The context 1000 corresponds to contents of the formatted log.

First, the control plane C extracts information regarding the processing that serves as a starting point of the operation in response to the request from the telemetry data of the type “EVENT” of the telemetry data group 720. Here, the time stamp “get contents method (inventory check)” of “db query” and the request ID “19690317-s5888y-123466” are extracted from the method of the type “EVENT” (2A).

Next, the control plane C extracts information indicating transition of the service #i that has operated in response to the request from the telemetry data of the type “LOG, TRACE” of the telemetry data group 720. Here, information indicating transition of the operated services “SERVICE1, SERVICE2, SERVICE1” is extracted from the telemetry data of the type “LOG” and the type “TRACE” of the telemetry data group 720 (2B), (2C), and (2D).

Next, the control plane C extracts input information from the telemetry data of the type “LOG” of the telemetry data group 720. Here, “P2 SET” is extracted (2E). Next, the control plane C extracts information regarding the operation of the service #i that has transitioned last from the telemetry data of the type “LOG” of the telemetry data group 720. Here, information regarding the operation of “01809” is extracted (2F).

Next, the control plane C extracts information when the operation in response to the request is terminated from the telemetry data of the type “METRIC” of the telemetry data group 720. Here, information regarding the time stamp of the completion flag of the operation, the metric data (total duration), and the status code is extracted (2G).

Furthermore, the control plane C extracts, as other information, the ID of the request user from the telemetry data of the type “LOG” of the telemetry data group 720. Here, “request user_id 752.254.211.38” is extracted (2H).

Furthermore, the control plane C searches the telemetry data group 720 for the error information and the warning information. Here, the error information and the warning information are not retrieved from the telemetry data group 720.

In FIG. 10B, the control plane C creates a formatted log 1001 from the context 1000. The control plane C sets the telemetry data group 720 and the formatted log 1001 in combination as a structured log (referred to as “structured log LG2” here).

Next, the control plane C refers to the formatted log 1001 and determines a level of the structured log according to a predefined assessment method. Here, the formatted log 1001 includes neither the error information nor the warning information. Thus, the control plane C determines that the level of the structured log is “Lv1”. Then, the control plane C sets the determined level “Lv1” in the formatted log 1001 (portion of the reference sign 1002 in FIG. 10B).

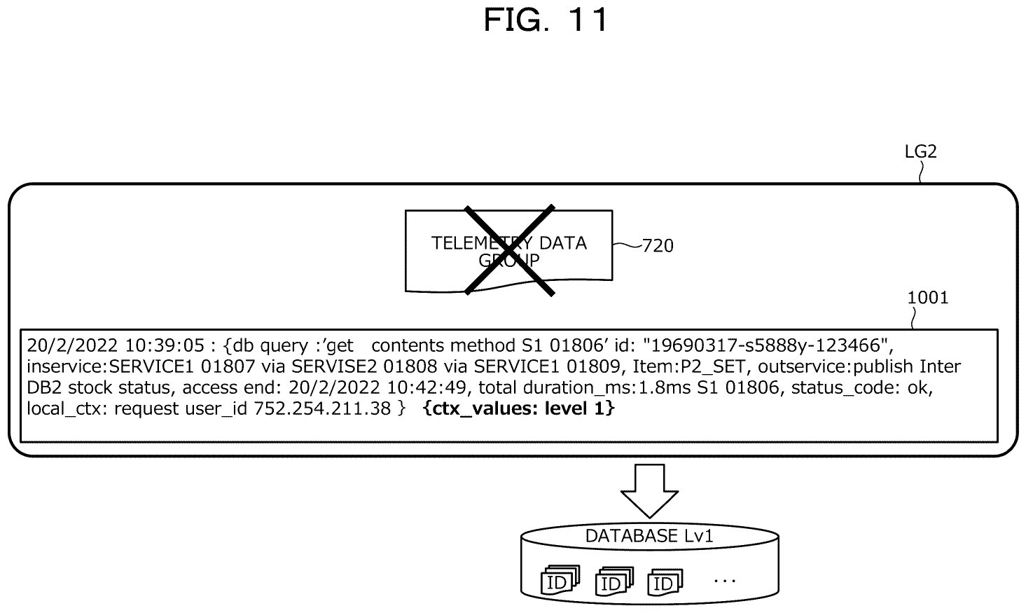

Next, exemplary storage of the structured log LG2 will be described with reference to FIG. 11.

FIG. 11 is an explanatory diagram illustrating second exemplary storage of the structured log. In FIG. 11, the control plane C adjusts the storage amount of the telemetry data group 720 in the structured log LG2 in the database 220. For example, the control plane C processes the telemetry data group 720 included in the structured log LG2 according to the level in the formatted log 1001.

Here, since the level in the formatted log 1001 is “Lv1”, the control plane C deletes the telemetry data group 720 from the structured log LG2. Then, the control plane C stores the structured log LG2 from which the telemetry data group 720 has been deleted in the database Lv1 in the database 220.

As described above, Case 1 is a case where the operation of the application based on the user request is normally started and the series of processing is completed, and the data amount transmitted to the database 220 is the minimum among Cases 1, 2, and 3 (Cases 2 and 3 will be described later).

### Case 2: Exemplary Level Determination and Exemplary DB Storage of Structured Log

Next, exemplary level determination and exemplary DB storage of the structured log in Case 2 will be described.

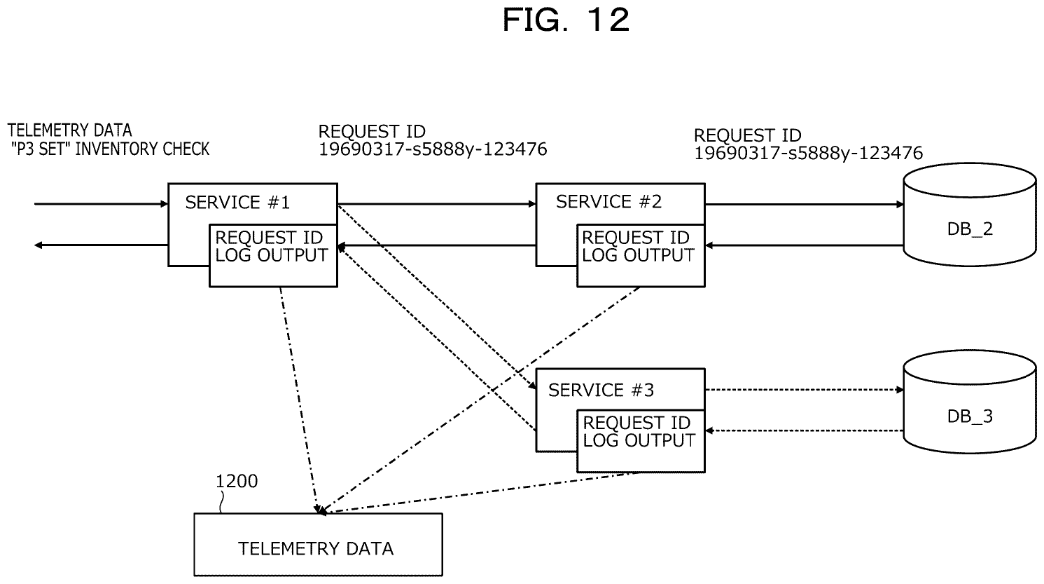

FIG. 12 is an explanatory diagram illustrating a second exemplary operation of the application. In a similar manner to Case 1, FIG. 12 illustrates the service #1 that processes a request from the user, and the services #2 and #3 that execute an operation requested from the service #1. Databases DB_2 and DB_3, which store information, are coupled to the services #2 and #3.

In Case 2, it is assumed that an inventory check of “P3 SET” is received from the user. In Case 2, the service #1 calls the service #2 to check the inventory information of “P3 SET”. Information (telemetry data) logged for each of the services #1 to #3 is collected in one location (control plane C) as telemetry data 1200.

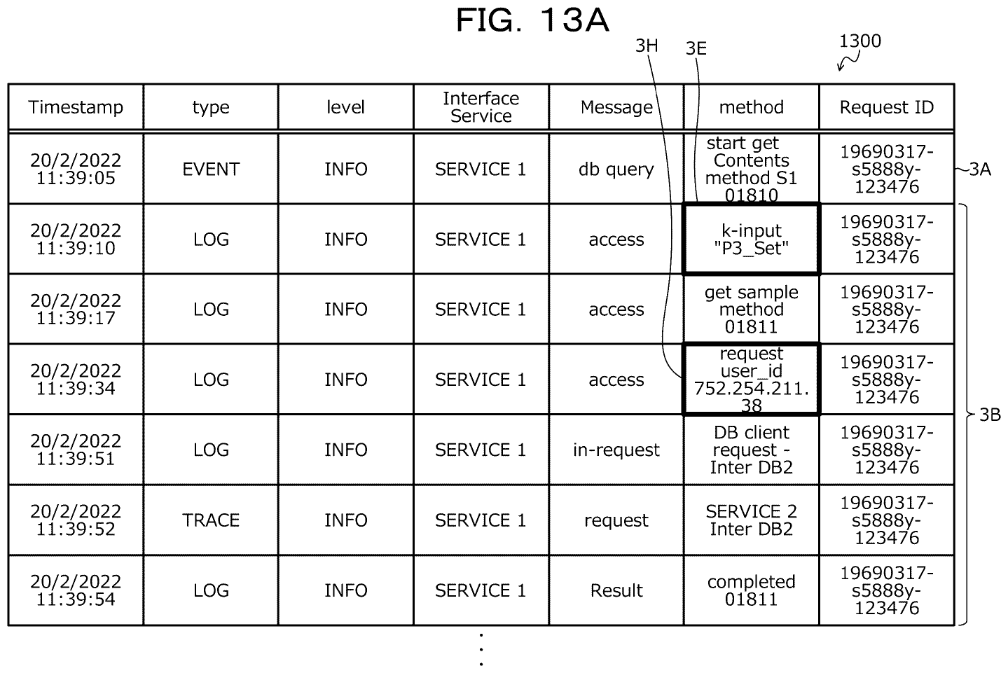

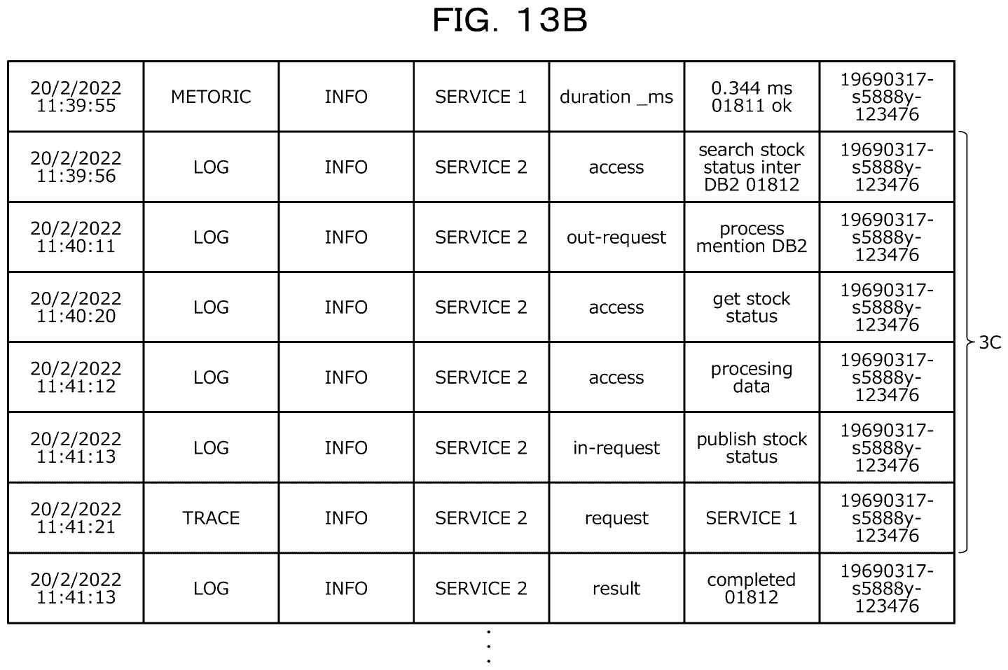

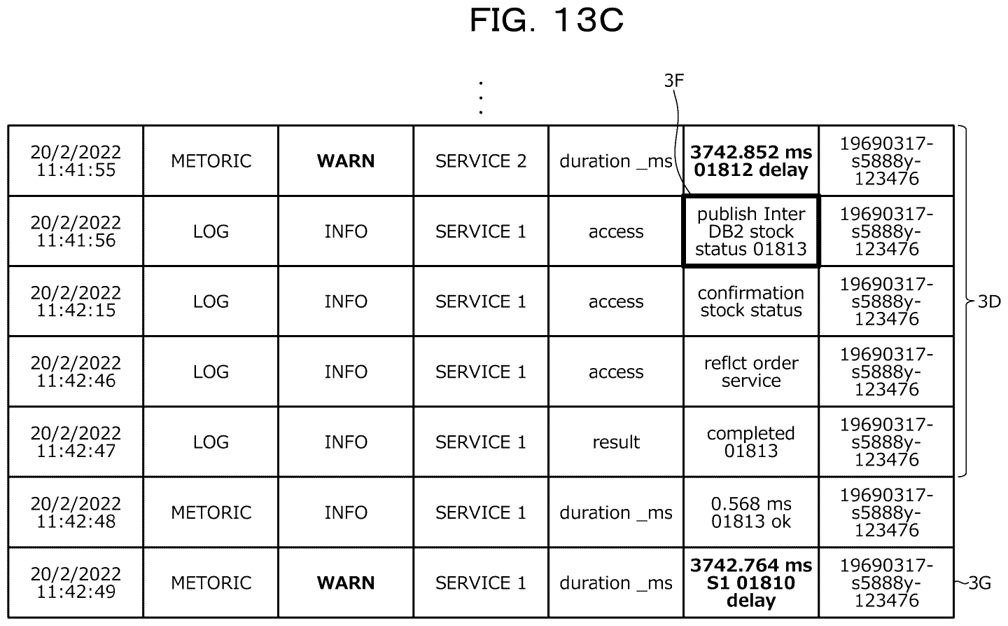

Next, the telemetry data 1200 will be described with reference to FIGS. 13A to 13C.

FIGS. 13A to 13C are explanatory diagrams illustrating a second exemplary sample of the telemetry data. In FIGS. 13A to 13C, a telemetry data group 1300 is an exemplary telemetry data group included in the telemetry data 1200 illustrated in FIG. 12.

The telemetry data group 1300 is obtained by arranging, in time series, the telemetry data (log information) with the same request ID (19690317-s5888y-123476) related to the request for the inventory check of “P3 SET”. The control plane C creates a formatted log from the telemetry data group 1300.

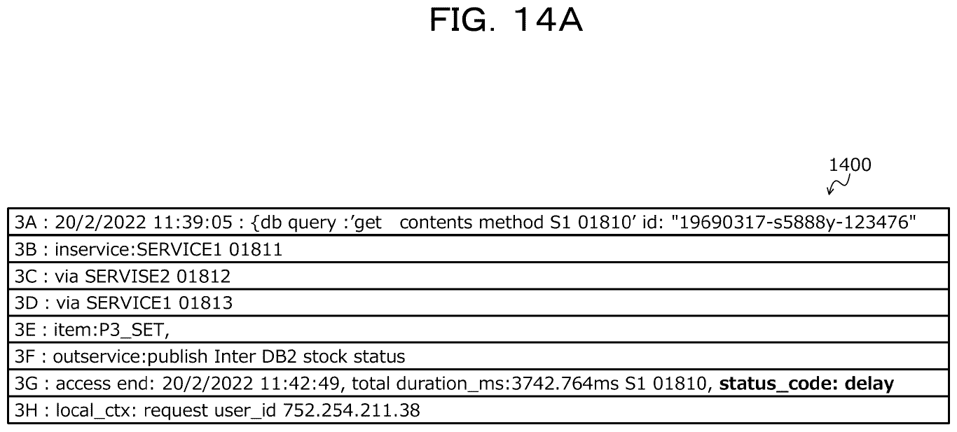

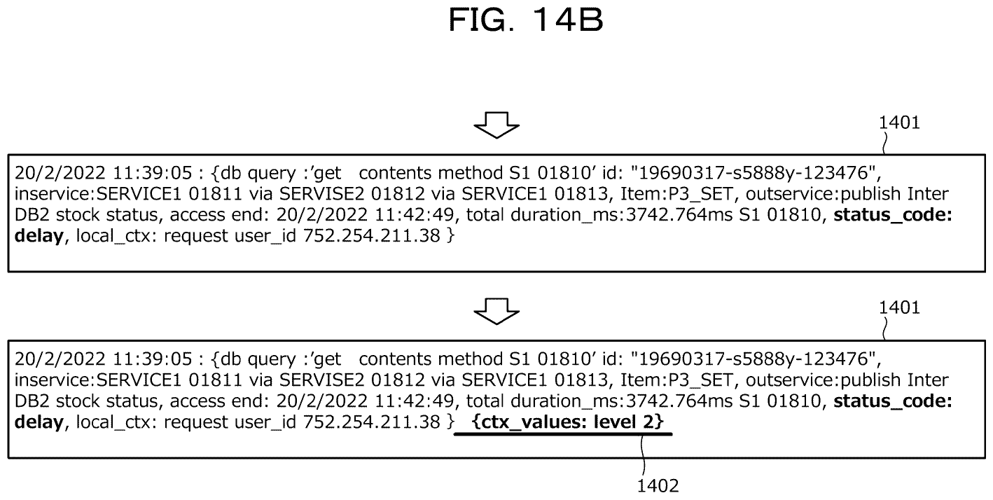

FIGS. 14A and 14B are explanatory diagrams illustrating third exemplary creation of the formatted log. In FIG. 14A, the control plane C creates, from the telemetry data group 1300, a context 1400 to be in a form of a unique log format for the user request of the inventory check of “P3 SET”. The context 1400 corresponds to contents of the formatted log.

First, the control plane C extracts information regarding the processing that serves as a starting point of the operation in response to the request from the telemetry data of the type “EVENT” of the telemetry data group 1300. Here, the time stamp “get contents method (inventory check)” of “db query” and the request ID “19690317-s5888y-123476” are extracted from the method of the type “EVENT” (3A).

Next, the control plane C extracts information indicating transition of the service #i that has operated in response to the request from the telemetry data of the type “LOG, TRACE” of the telemetry data group 1300. Here, information indicating transition of the operated services “SERVICE1, SERVICE2, SERVICE1” is extracted from the telemetry data of the type “LOG” and the type “TRACE” of the telemetry data group 1300 (3B), (3C), and (3D).

Next, the control plane C extracts input information from the telemetry data of the type “LOG” of the telemetry data group 1300. Here, “P3 SET” is extracted (3E). Next, the control plane C extracts information regarding the operation of the service #i that has transitioned last from the telemetry data of the type “LOG” of the telemetry data group 1300. Here, information regarding the operation of “01813” is extracted (3F).

Next, the control plane C extracts information when the operation in response to the request is terminated from the telemetry data of the type “METRIC” of the telemetry data group 1300. Here, the time stamp of the completion flag of the operation and the metric data (total duration) are extracted (3G).

Furthermore, the control plane C searches the telemetry data group 1300 for the error information and the warning information. Here, the warning information (level “WARN”) is retrieved from the telemetry data group 1300, and the status code (status_code: delay) of the telemetry data including the warning information is extracted (3G).

Furthermore, the control plane C extracts, as other information, the ID of the request user from the telemetry data of the type “LOG” of the telemetry data group 1300. Here, “request user_id 752.254.211.38” is extracted (3H).

In FIG. 14B, the control plane C creates a formatted log 1401 from the context 1400. The control plane C sets the telemetry data group 1300 and the formatted log 1401 in combination as a structured log (referred to as “structured log LG3” here).

Next, the control plane C refers to the formatted log 1401 and determines a level of the structured log LG3 according to a predefined assessment method. Here, the warning information is included in the formatted log 1401. Furthermore, although the warning information is included, the processing for the user request of the inventory check of “P3 SET” has been completed, and thus it may be said that the event does not affect the linked service. The completion of the processing for the user request is specified from the status code “ok”, for example.

Thus, the control plane C determines that the level of the structured log LG3 is “Lv2”. Then, the control plane C sets the determined level “Lv2” in the formatted log 1401 (portion of the reference sign 1402 in FIG. 14B).

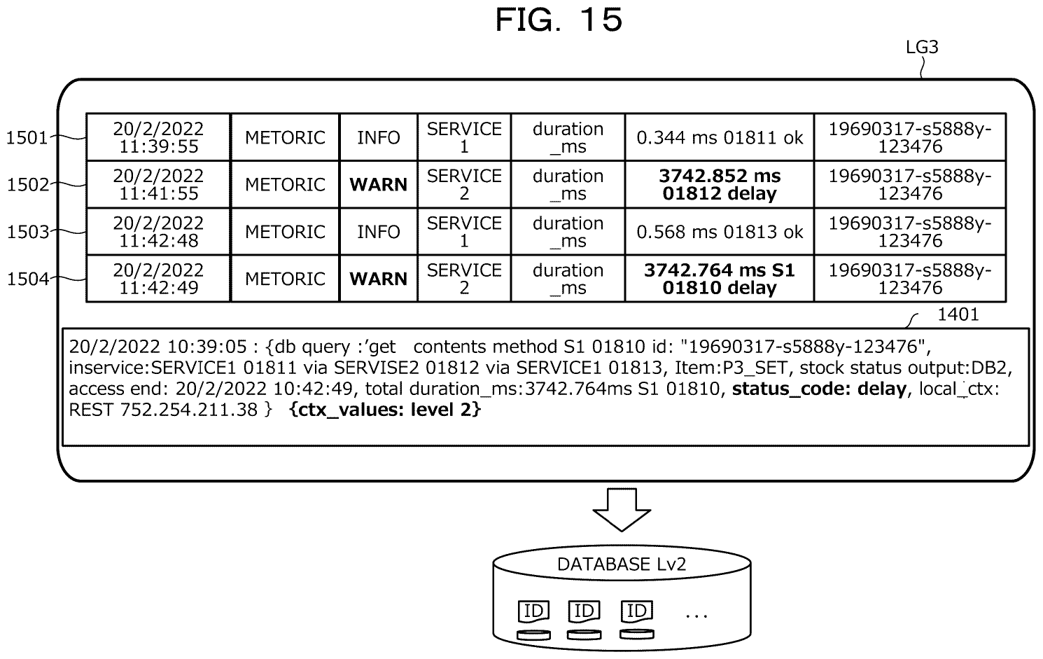

Next, exemplary storage of the structured log LG3 will be described with reference to FIG. 15.

FIG. 15 is an explanatory diagram illustrating third exemplary storage of the structured log. In FIG. 15, the control plane C adjusts the storage amount of the telemetry data group 1300 in the structured log LG3 in the database 220. For example, the control plane C processes the telemetry data group 1300 included in the structured log LG3 according to the level in the formatted log 1401.

Here, since the level in the formatted log 1401 is “Lv2”, the control plane C deletes telemetry data other than metrics data in the telemetry data group 1300 in the structured log LG3. The metrics data is telemetry data of the same data type as the telemetry data including the warning information, and is information for confirming a suspicious portion. As a result, only metrics data 1501 to 1504 remains in the telemetry data group 1300 in the structured log LG3.

Then, the control plane C stores the structured log LG3 (metrics data 1501 to 1504+formatted log 1401) in the database Lv2 in the database 220.

Case 2 is a case where, although the operation of the application based on the user request is normally started and the series of processing is terminated, a processing delay occurs for some reason. In Case 2, the data transmitted to the database 220 is a set of the formatted log 1401 and the metrics data 1501 to 1504, which are useful for analyzing the delay position. In Case 2, the data amount transmitted to the database 220 is made smaller than that in Case 3 to be described later.

### Case 3: Exemplary Level Determination and Exemplary DB Storage of Structured Log

Next, exemplary level determination and exemplary DB storage of the structured log in Case 3 will be described.

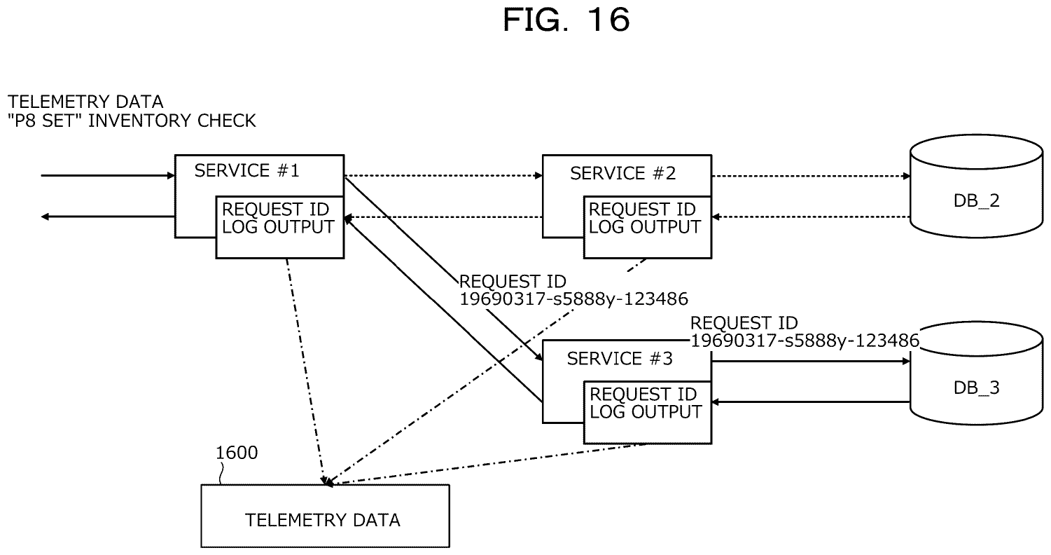

FIG. 16 is an explanatory diagram illustrating a third exemplary operation of the application. In a similar manner to Case 1, FIG. 16 illustrates the service #1 that processes a request from the user, and the services #2 and #3 that execute an operation requested from the service #1. Databases DB_2 and DB_3, which store information, are coupled to the services #2 and #3.

In Case 3, it is assumed that an inventory check of “P8 SET” is received from the user. In Case 2, the service #1 calls the service #3 to check the inventory information of “P8 SET”. Information (telemetry data) logged for each of the services #1 to #3 is collected in one location (control plane C) as telemetry data 1600.

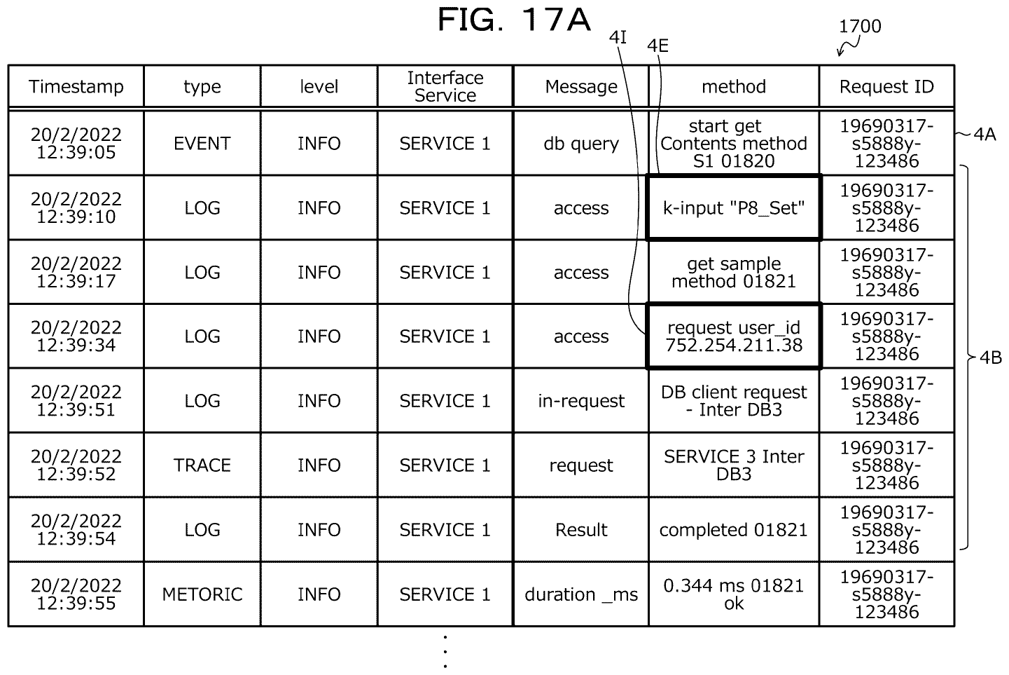

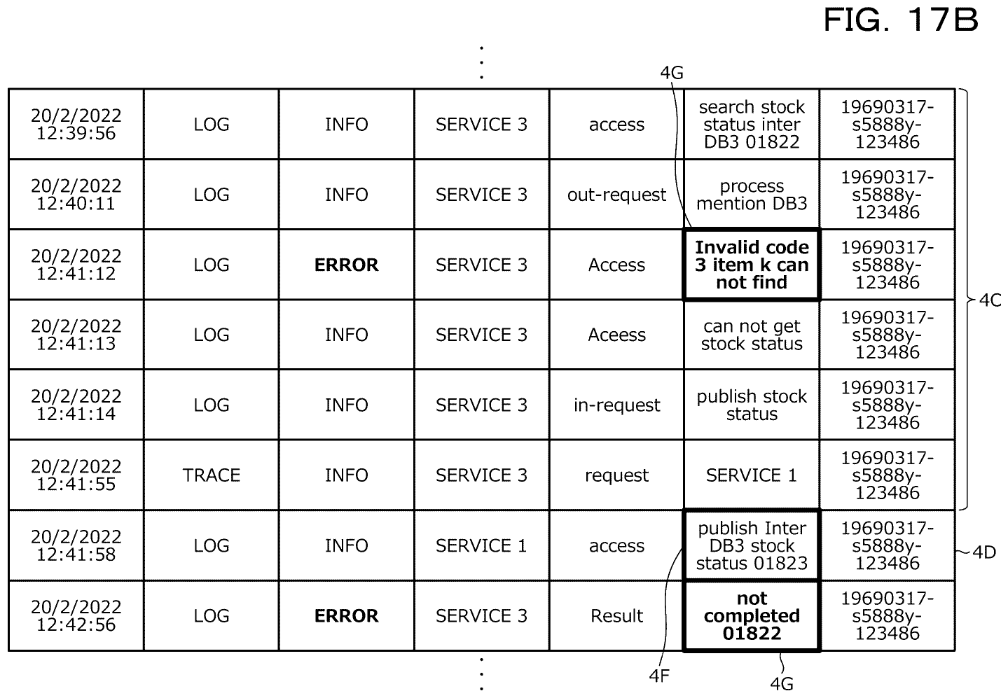

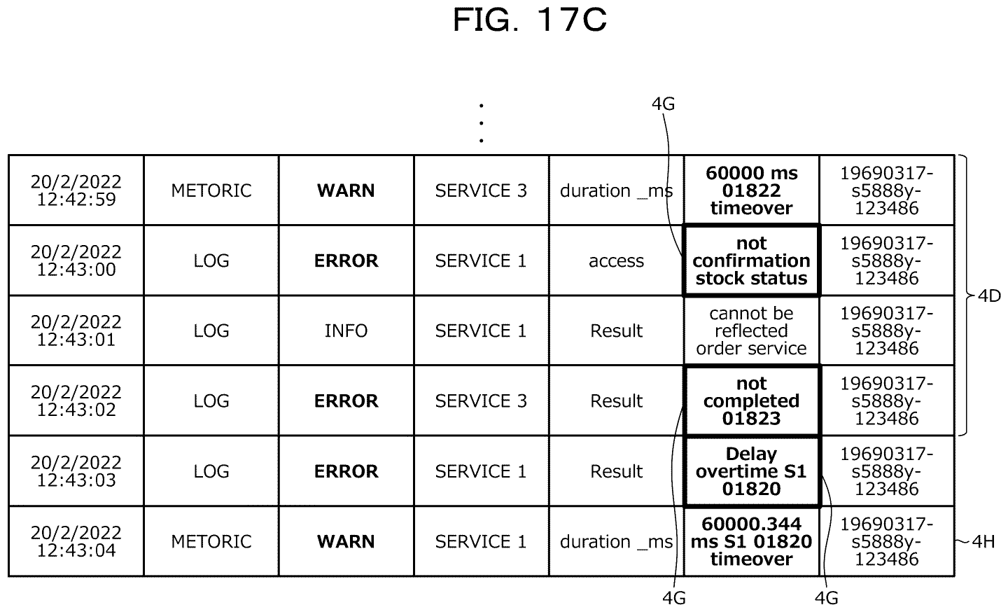

Next, the telemetry data 1600 will be described with reference to FIGS. 17A to 17C.

FIGS. 17A to 17C are explanatory diagrams illustrating a third exemplary sample of the telemetry data. In FIGS. 17A to 17C, a telemetry data group 1700 is an exemplary telemetry data group included in the telemetry data 1600 illustrated in FIG. 16.

The telemetry data group 1700 is obtained by arranging, in time series, the telemetry data (log information) with the same request ID (19690317-s5888y-123486) related to the request for the inventory check of “P8 SET”. The control plane C creates a formatted log from the telemetry data group 1700.

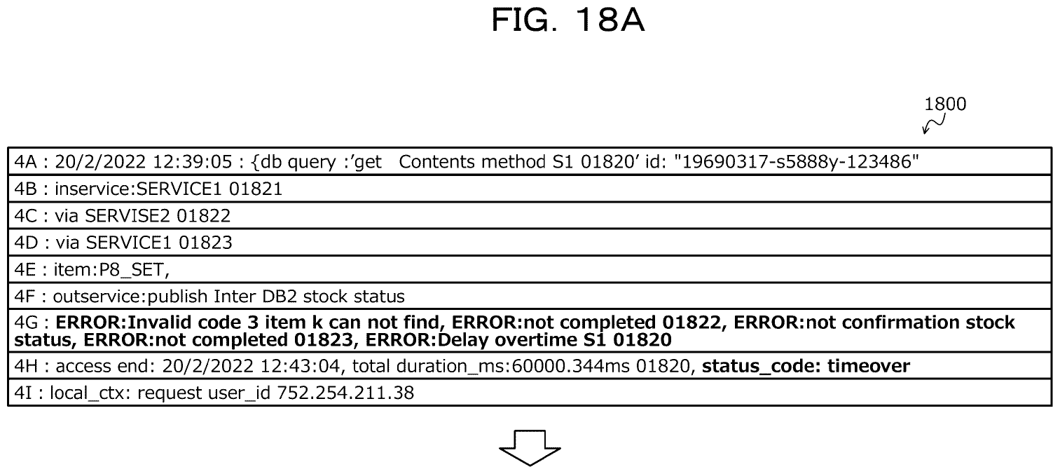

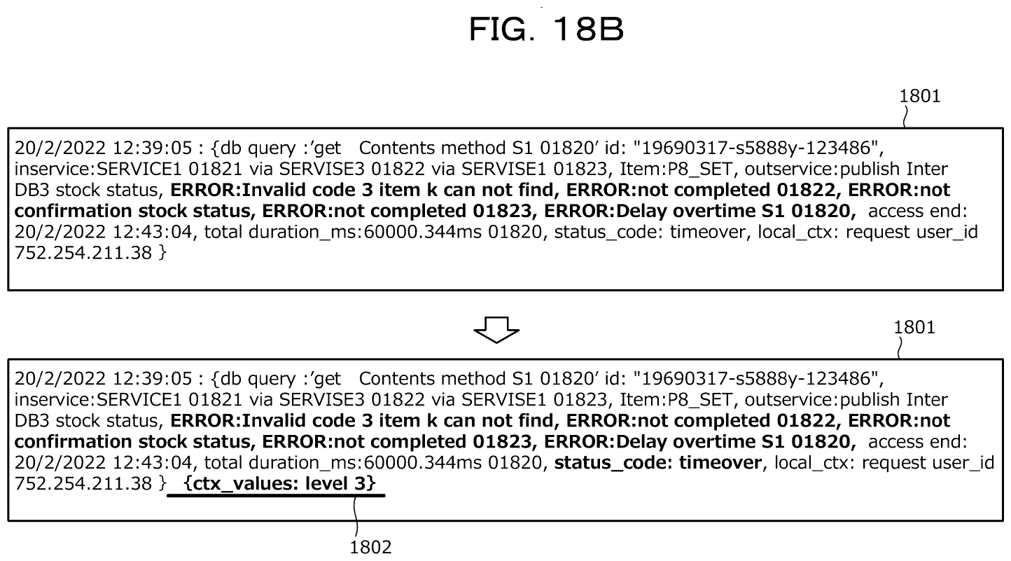

FIGS. 18A and 18B are explanatory diagrams illustrating fourth exemplary creation of the formatted log. In FIG. 18A, the control plane C creates, from the telemetry data group 1700, a context 1800 to be in a form of a unique log format for the user request of the inventory check of “P8 SET”. The context 1800 corresponds to contents of the formatted log.

First, the control plane C extracts information regarding the processing that serves as a starting point of the operation in response to the request from the telemetry data of the type “EVENT” of the telemetry data group 1700. Here, the time stamp “get contents method (inventory check)” of “db query” and the request ID “19690317-s5888y-123486” are extracted from the method of the type “EVENT” (4A).

Next, the control plane C extracts information indicating transition of the service #i that has operated in response to the request from the telemetry data of the type “LOG, TRACE” of the telemetry data group 1700. Here, information indicating transition of the operated services “SERVICE1, SERVICE3, SERVICE1” is extracted from the telemetry data of the type “LOG” and the type “TRACE” of the telemetry data group 1700 (4B), (4C), and (4D).

Next, the control plane C extracts input information from the telemetry data of the type “LOG” of the telemetry data group 1700. Here, “P8 SET” is extracted (4E). Next, the control plane C extracts information regarding the operation of the service #i that has transitioned last from the telemetry data of the type “LOG” of the telemetry data group 1700. Here, information regarding the operation of “01823” is extracted (4F).

Next, the control plane C extracts information when the operation in response to the request is terminated from the telemetry data of the type “METRIC” of the telemetry data group 1700. Here, the time stamp of the completion flag of the operation and the metric data (total duration) are extracted (4H).

Furthermore, the control plane C extracts, as other information, the ID of the request user from the telemetry data of the type “LOG” of the telemetry data group 1700. Here, “request user_id 752.254.211.38” is extracted (4I).

Furthermore, the control plane C searches the telemetry data group 1700 for the error information and the warning information. Here, the error information (level “ERROR”) is retrieved from the telemetry data group 1700, and information regarding all pieces of the telemetry data (contents of the method here) including the error information is extracted (4G). Furthermore, the warning information (level “WARN”) is retrieved from the telemetry data group 1700, and the status code (status_code: timeover) of the telemetry data including the warning information is extracted (4H).

In FIG. 18B, the control plane C creates a formatted log 1801 from the context 1800. The control plane C sets the telemetry data group 1700 and the formatted log 1801 in combination as a structured log (referred to as “structured log LG4” here).

Next, the control plane C refers to the formatted log 1801 and determines a level of the structured log LG4 according to a predefined assessment method. Here, the error information is included in the formatted log 1801. Furthermore, the processing for the user request of the inventory check of “P8 SET” is not completed, and it may be said that the event affects the linked service. The incompletion of the processing for the user request is specified from the status code “timeover”, for example.

Thus, the control plane C determines that the level of the structured log LG4 is “Lv3”. Then, the control plane C sets the determined level “Lv3” in the formatted log 1801 (portion of the reference sign 1802 in FIG. 18B).

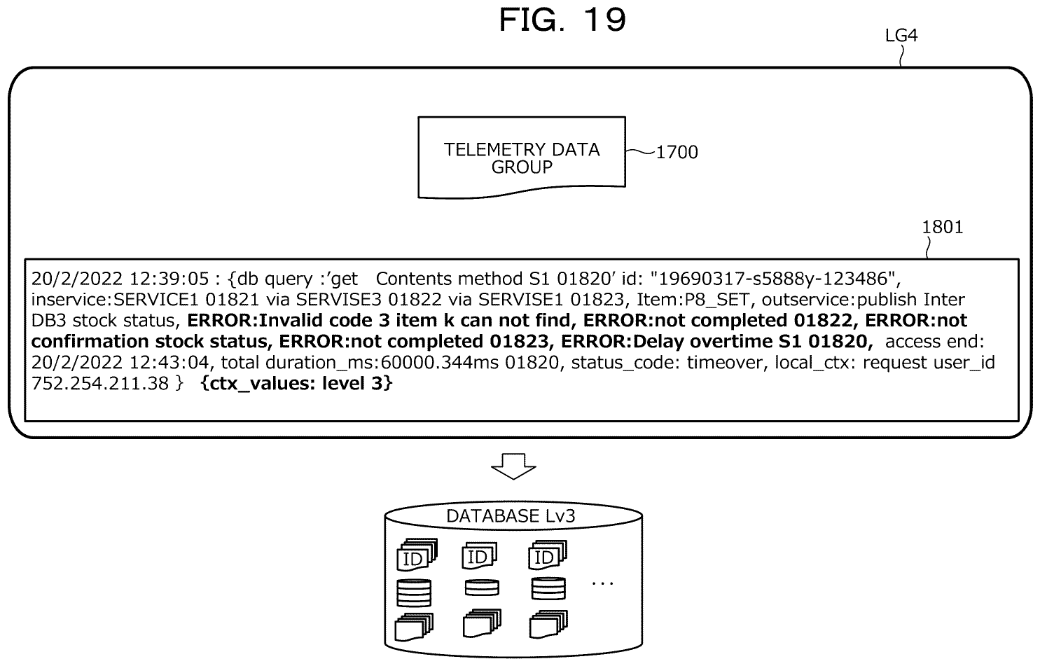

Next, exemplary storage of the structured log LG4 will be described with reference to FIG. 19.

FIG. 19 is an explanatory diagram illustrating fourth exemplary storage of the structured log. In FIG. 19, the control plane C adjusts the storage amount of the telemetry data group 1700 in the structured log LG4 in the database 220. For example, the control plane C processes the telemetry data group 1700 included in the structured log LG4 according to the level in the formatted log 1801.

Here, since the level in the formatted log 1801 is “Lv3”, the control plane C maintains the entire telemetry data group 1700 in the structured log LG4. Then, the control plane C stores the structured log LG4 (telemetry data group 1700+formatted log 1801) in the database Lv3 in the database 220.

Case 3 is a case where the process is terminated while the operation of the application based on the user request is incomplete due to a failure. In Case 3, the incompletion of the process has occurred for some reason, and thus the data transmitted to the database 220 is a set of the formatted log 1801 and the entire telemetry data group 1700 useful for identifying and analyzing the failure point.

### [Log Management Processing Procedure of Log Management Server 201]

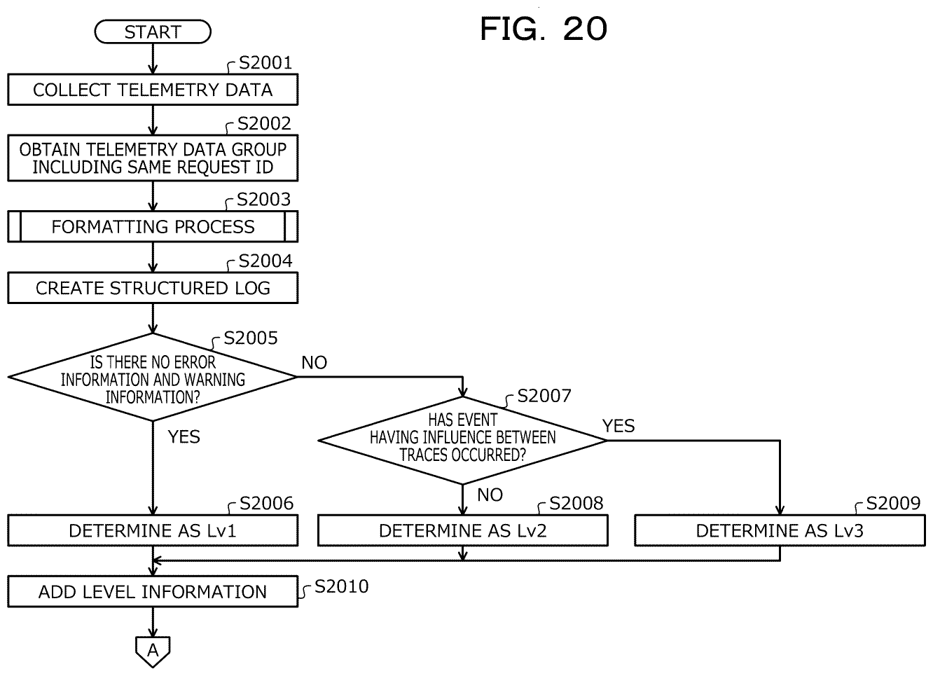

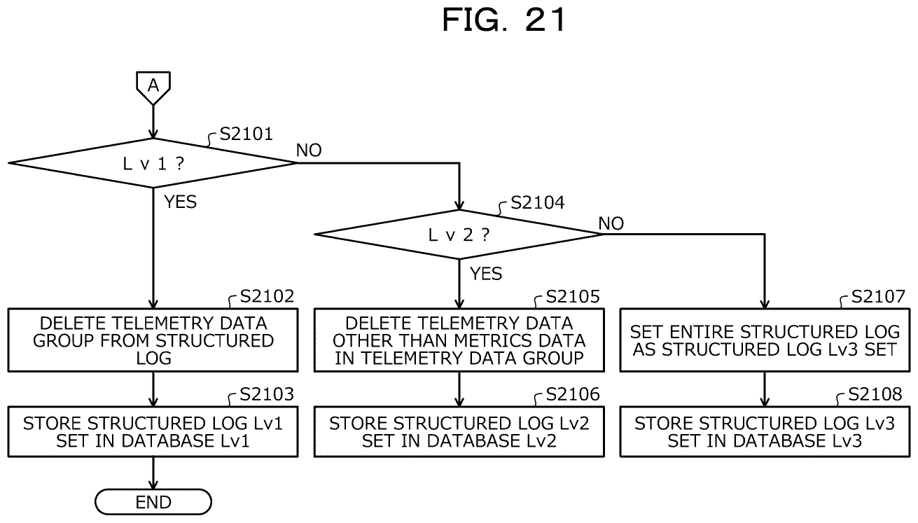

Next, a log management processing procedure of the log management server 201 will be described with reference to FIGS. 20 and 21.

FIGS. 20 and 21 are flowcharts illustrating an example of the log management processing procedure of the log management server 201. In the flowchart of FIG. 20, first, the log management server 201 collects the telemetry data from each service #i (operation S2001). The collected telemetry data is temporarily stored in, for example, a buffer pool provided in the memory 302.

Next, the log management server 201 obtains a telemetry data group including the same request ID among the collected telemetry data (operation S2002). Then, the log management server 201 performs a formatting process on the obtained telemetry data group (operation S2003).

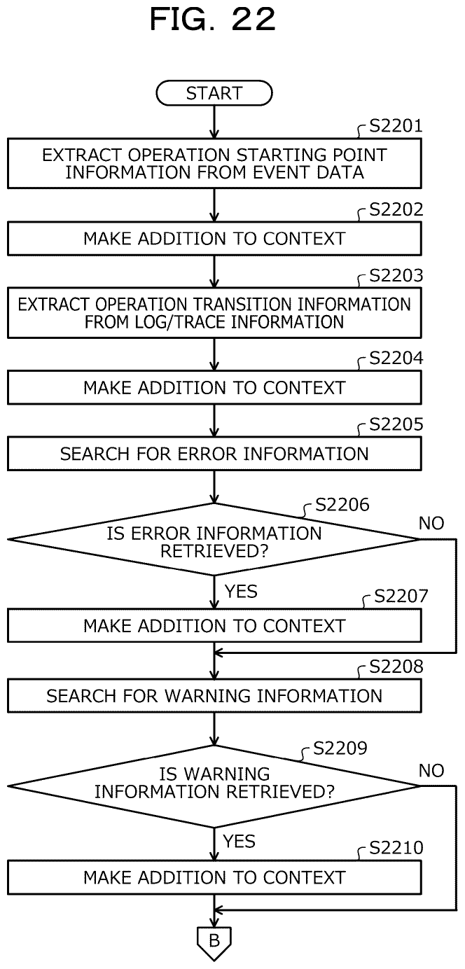

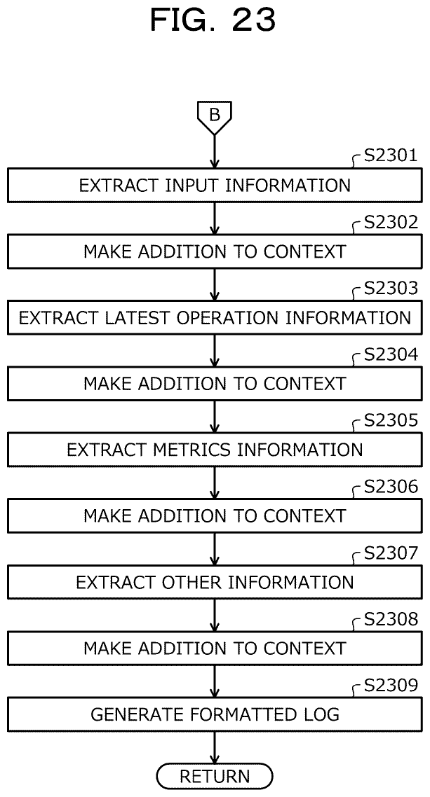

The formatting process is a process of creating formatted log information (formatted log) for the telemetry data group. A specific processing procedure of the formatting process will be described later with reference to FIGS. 22 and 23.

Next, the log management server 201 creates a structured log, which is a set of the formatted log and the telemetry data group (operation S2004). Then, the log management server 201 refers to the formatted log in the structured log, and determines whether there is error information or warning information (operation S2005).

Here, if there is neither the error information nor the warning information (Yes in operation S2005), the log management server 201 determines that the level of the structured log is “Lv1” (operation S2006), and proceeds to operation S2010.

On the other hand, if there is at least one of the error information or the warning information (No in operation S2005), the log management server 201 determines whether or not an event that exerts influence between traces has occurred (operation S2007). For example, the log management server 201 determines that the event that exerts influence between traces has occurred if there is the error information. Furthermore, if there is no error information while there is the warning information, the log management server 201 determines that no event that exerts influence between traces has occurred.

Here, if no event that exerts influence between traces has occurred (No in operation S2007), the log management server 201 determines that the level of the structured log is “Lv2” (operation S2008), and proceeds to operation S2010.

On the other hand, if the event that exerts influence between traces has occurred (Yes in operation S2007), the log management server 201 determines that the level of the structured log is “Lv3” (operation S2009). Then, the log management server 201 adds level information indicating the determined level to the formatted log in the structured log (operation S2010), and proceeds to operation S2101 illustrated in FIG. 21.

In the flowchart of FIG. 21, first, the log management server 201 refers to the formatted log in the structured log, and determines whether or not the level of the structured log is “Lv1” (operation S2101).

Here, in the case of “Lv1” (Yes in operation S2101), the log management server 201 deletes the telemetry data group from the structured log to obtain a structured log Lv1 set (operation S2102). Then, the log management server 201 stores the structured log Lv1 set in the database Lv1 in the database 220 (operation S2103), and terminates the series of processing based on the present flowchart.

Furthermore, if “Lv1” is not satisfied in operation S2101 (No in operation S2101), the log management server 201 refers to the formatted log in the structured log, and determines whether or not the level of the structured log is “Lv2” (operation S2104).

Here, in the case of “Lv2” (Yes in operation S2104), the log management server 201 deletes the telemetry data other than the metrics data in the telemetry data group in the structured log to obtain a structured log Lv2 set (operation S2105). Then, the log management server 201 stores the structured log Lv2 set in the database Lv2 in the database 220 (operation S2106), and terminates the series of processing based on the present flowchart.

Furthermore, if “Lv2” is not satisfied in operation S2104 (No in operation S2104), the log management server 201 sets the entire structured log as a structured log Lv3 set (operation S2107). Then, the log management server 201 stores the structured log Lv3 set in the database Lv3 in the database 220 (operation S2108), and terminates the series of processing based on the present flowchart.

As a result, the log management server 201 is enabled to adjust the storage amount of the telemetry data collected from each service #i in the database 220. Note that the processing in and after operation S2003 is executed for each telemetry data group including the same request ID obtained in operation S2002, for example.

Next, a specific processing procedure of the formatting process in operation S2003 will be described with reference to FIGS. 22 and 23.

FIGS. 22 and 23 are flowcharts illustrating an example of the specific processing procedure of the formatting process. In the flowchart of FIG. 22, first, the log management server 201 extracts operation starting point information from event data in the telemetry data group (operation S2201).

The event data is telemetry data of the type “EVENT”. The operation starting point information includes, for example, a request ID, and a time stamp, a message, a method, and the like of an event that serves as a starting point of the operation. Then, the log management server 201 adds the operation starting point information to the context (operation S2202).

Next, the log management server 201 extracts operation transition information from log/trace data in the telemetry data group (operation S2203). The log/trace data is telemetry data of the type “LOG” and telemetry data of the type “TRACE”. The operation transition information is information indicating transition of microservices that have operated according to the event that serves as a starting point.

Then, the log management server 201 adds the operation transition information to the context (operation S2204). Next, the log management server 201 searches the telemetry data group for the error information (operation S2205). For example, the log management server 201 searches for log data of the level “ERROR”.

Then, the log management server 201 determines whether or not the error information is retrieved (operation S2206). Here, if the error information is not retrieved (No in operation S2206), the log management server 201 proceeds to operation S2208.

On the other hand, if the error information is retrieved (Yes in operation S2206), the log management server 201 adds the retrieved error information to the context (operation S2207). Next, the log management server 201 searches the telemetry data group for the warning information (operation S2208). For example, the log management server 201 searches for metrics data of the level “WARN”. The metrics data is telemetry data of the type “METRIC”.

Then, the log management server 201 determines whether or not the warning information is retrieved (operation S2209). Here, if the warning information is not retrieved (No in operation S2209), the log management server 201 proceeds to operation S2301 illustrated in FIG. 23. On the other hand, if the warning information is retrieved (Yes in operation S2209), the log management server 201 adds the retrieved warning information to the context (operation S2210), and proceeds to operation S2301 illustrated in FIG. 23.

In the flowchart of FIG. 23, first, the log management server 201 extracts input information associated with the request ID from the telemetry data group (operation S2301). The input information is specified by, for example, a character string of “input”. Then, the log management server 201 adds the input information to the context (operation S2302).

Next, the log management server 201 extracts the latest operation information associated with the request ID from the telemetry data group (operation S2303). The latest operation information is information regarding the operation of the microservice that has transitioned last. Then, the log management server 201 adds the latest operation information to the context (operation S2304).

Next, the log management server 201 extracts, from the telemetry data group, metrics information when the operation for the series of processing is terminated (operation S2305). The metrics information includes, for example, a time stamp, a completion flag, a metric (numerical data), a status code, and the like when the operation for the series of processing is terminated. Then, the log management server 201 adds the metrics information to the context (operation S2306).

Next, the log management server 201 extracts other information from the telemetry data group (operation S2307). Examples of the other information include Internet protocol (IP) addresses of the server and the client, a user ID, and the like. The log management server 201 adds the other information to the context (operation S2308).

Then, the log management server 201 refers to the context, generates a formatted log for the telemetry data group (operation S2309), and returns to the operation in which the formatting process has been called.

As a result, the log management server 201 is enabled to generate the formatted log, which is unique information among pieces of the telemetry data having the same request ID.

As described above, according to the log management server 201 according to the embodiment, it becomes possible to obtain the telemetry data group including the same request ID among the telemetry data collected from the respective services #i of the services #1 to #m. The telemetry data is observation information regarding the processing executed in each service #i. Furthermore, according to the log management server 201, it becomes possible to retrieve the error information and the warning information from the obtained telemetry data group. The error information indicates occurrence of an error. The warning information indicates occurrence of an event that may cause an error. Then, according to the log management server 201, it becomes possible to store, in the database 220 that serves as a storage location, some or all of the pieces of information of the telemetry data group depending on a search result of the search.

As a result, the log management server 201 is enabled to adjust the storage amount in the database 220 that serves as a storage location of the telemetry data. For example, the log management server 201 is enabled to adjust, in units of the telemetry data group associated with the same request ID, whether to store only partial information or the entire information of the telemetry data group depending on whether or not the error information or the warning information is included. Thus, the log management server 201 is enabled to reduce the storage capacity to be used to store the telemetry data in the database 220 while retaining information needed for performance evaluation of the application and the like.

Furthermore, according to the log management server 201, predetermined partial information is extracted from the telemetry data group with reference to the data type of each piece of the telemetry data group including the telemetry data of different data types, whereby it becomes possible to create a formatted log (formatted log information) including the extracted partial information. Examples of the data type include an event, a metric, a log, and a trace. Then, according to the log management server 201, only the created formatted log may be stored in the database 220 (e.g., database Lv1) for the telemetry data group in the case where the error information and the warning information are not retrieved from the telemetry data group.

As a result, the log management server 201 is enabled to suppress the storage amount in the database 220 by setting only the bare minimum of information (predetermined partial information) for an analyst as the storage target to specify the processing executed in response to the request for the telemetry data group when the system normally operates to complete the series of processing.

Furthermore, according to the log management server 201, it becomes possible to specify the telemetry data of the same data type as the telemetry data including the warning information from the telemetry data group in the case where no error information is retrieved and the warning information is retrieved from the telemetry data group. Then, according to the log management server 201, it becomes possible to store, for the telemetry data group, the specified telemetry data in the database 220 (e.g., database Lv2) together with the formatted log.

As a result, the log management server 201 is enabled to suppress the storage amount in the database 220 by setting the information needed to analyze the event as the storage target for the telemetry data group when the event that may cause an error has occurred while there is no error in the series of processing. Furthermore, the log management server 201 is enabled to easily specify the processing executed in response to the request by storing the formatted log together.

Furthermore, according to the log management server 201, it becomes possible to store the telemetry data group in the database 220 (e.g., database Lv3) together with the formatted log in the case where the error information is retrieved from the telemetry data group.

As a result, the log management server 201 is enabled to set the entire telemetry data group as the storage target for the telemetry data group when some error has occurred and the system has not normally operated. Thus, the log management server 201 is enabled to avoid a situation where information to be used to identify the failure point and to investigate a cause is insufficient at a time of occurrence of a serious failure or the like. Furthermore, the log management server 201 is enabled to easily specify the processing executed in response to the request by storing the formatted log together.

Furthermore, according to the log management server 201, it becomes possible to extract, from the telemetry data of the event in the telemetry data group, the information regarding the processing that serves as a starting point of the operation in response to the request and the request ID to create a formatted log.

As a result, the log management server 201 is enabled to specify the processing executed in response to the request from the request ID and the event information.

Furthermore, according to the log management server 201, it becomes possible to extract, from the telemetry data of the log and trace in the telemetry data group, the information indicating transition of the microservices that have operated in response to the request to create a formatted log.

As a result, the log management server 201 is enabled to specify the microservices that have operated in response to the request.

Furthermore, according to the log management server 201, it becomes possible to further extract, from the telemetry data of the log in the telemetry data group, the information regarding the operation of the microservice that has transitioned last to create a formatted log.

As a result, the log management server 201 is enabled to confirm the contents of the operation of the microservice that has transitioned last at the time of specifying the processing executed in response to the request.

Furthermore, according to the log management server 201, it becomes possible to further extract, from the telemetry data of the metric in the telemetry data group, the metrics data when the operation in response to the request is terminated to create a formatted log.

As a result, the log management server 201 is enabled to confirm the metrics data when the operation for the request is terminated at the time of specifying the processing executed in response to the request.

Furthermore, according to the log management server 201, it becomes possible to further extract, from the telemetry data of the metric in the telemetry data group, the status code when the operation in response to the request is terminated to create a formatted log.

As a result, the log management server 201 is enabled to confirm the status code when the operation for the request is terminated at the time of specifying the processing executed in response to the request.

Furthermore, according to the log management server 201, it becomes possible to add the warning information to the formatted log in the case where the warning information is retrieved from the telemetry data group.

As a result, the log management server 201 is enabled to easily confirm what kind of event (event that may cause an error) has occurred from the formatted log without checking the contents of the telemetry data stored together with the formatted log.

Furthermore, according to the log management server 201, it becomes possible to add the error information to the formatted log in the case where the error information is retrieved from the telemetry data group.

As a result, the log management server 201 is enabled to easily confirm what kind of error has occurred from the formatted log without checking the contents of the telemetry data stored together with the formatted log.

As described above, according to the log management server 201, it becomes possible to analyze, from the structured log, whether the processing of the application (system) including the plurality of microservices is normal processing or processing in which a failure or an abnormality has occurred. As a result, the log management server 201 is enabled to reduce the storage capacity to be used to store the telemetry data and to reduce the storage area to be secured by storing only more useful data among the pieces of telemetry data collected to monitor the normality of the processing of the application.

Furthermore, since the log management server 201 is enabled to suppress the data transfer amount and the memory use amount of the stored data in a case of constructing the database 220 on the cloud or the like, it becomes possible to reduce the charge amount to reduce the operation cost as compared with the case of storing all pieces of data as in the related art. Furthermore, the log management server 201 is enabled to selectively use the storage area that serves as a storage location of the stored data in the database 220 depending on the level (Lv1, Lv2, or Lv3). Thus, the log management server 201 makes it possible to easily call data to be deleted or transferred at a time of implementing deletion or external transfer of the stored data.

Note that the log management method described in the present embodiment may be implemented by a computer, such as a personal computer, a workstation, or the like, executing a program prepared in advance. The present log management program is recorded in a computer-readable recording medium, such as a hard disk, a flexible disk, a CD-ROM, a DVD, a USB memory, or the like, and is executed by being read from the recording medium by the computer. Furthermore, the present log management program may be distributed via a network, such as the Internet or the like.

Furthermore, the log management device 101 (log management server 201) described in the present embodiments may also be implemented by a special-purpose integrated circuit (IC), such as a standard cell, a structured application specific integrated circuit (ASIC), or the like, or a programmable logic device (PLD), such as a field-programmable gate array (FPGA) or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A log management device comprising:
a memory; and
a processor coupled to the memory and configured to:
obtain observation information group including observation information that includes a request ID same each other that identifies a series of processing executed in response to a request among pieces of observation information related to processing executed in each microservice, the pieces of the observation information being collected from each microservice of a plurality of the microservices;
search the obtained observation information group for error information that indicates occurrence of an error and warning information that indicates occurrence of an event to be a cause of the error; and
store at least partial information of the observation information group in a database that serves as a storage location according to a search result of the error information and the warning information.

2. The log management device according to claim 1,
wherein the observation information group includes the observation information of a different data type, and
wherein the processor is configured to:
extract predetermined partial information from the observation information group with reference to the data type of each piece of the observation information group to create formatted log information that includes the extracted partial information; and
when the error information and the warning information are not retrieved from the observation information group, store only the created formatted log information for the observation information group in the database.

3. The log management device according to claim 2,
wherein the processor is configured to:
when the error information is not retrieved and the warning information is retrieved from the observation information group, specify the observation information of the same data type as the observation information that includes the warning information in the observation information group; and
store the specified observation information in the database together with the formatted log information for the observation information group.

4. The log management device according to claim 2,
wherein the processor is configured to:
when the error information is retrieved from the observation information group, store the observation information group in the database together with the formatted log information.

5. The log management device according to claim 2,
wherein the observation information group includes the observation information of the data type including at least an event, a metric, a log, and a trace, and
wherein the partial information includes the request ID and information of processing that serves as a starting point of an operation in response to the request, the information of processing being extracted from the observation information of the event in the observation information group.

6. The log management device according to claim 5, wherein the partial information includes first information that indicates transition of the microservices that have operated in response to the request, the first information being extracted from the observation information of the log and the trace in the observation information group.

7. The log management device according to claim 6, wherein the partial information includes second information of the operation of the microservice that has transitioned last, the second information being extracted from the observation information of the log in the observation information group.

8. The log management device according to claim 6, wherein the partial information includes metric data when the operation in response to the request is terminated, the metric data being extracted from the observation information of the metric in the observation information group.

9. The log management device according to claim 6, wherein the partial information includes a status code when the operation in response to the request is terminated, the status code being extracted from the observation information of the metric in the observation information group.

10. The log management device according to claim 3, wherein the processor is configured to add the warning information to the formatted log information when the warning information is retrieved from the observation information group.

11. The log management device according to claim 4, wherein the processor is configured to add the error information to the formatted log information when the error information is retrieved from the observation information group.

12. The log management device according to claim 2, wherein the processor is configured to store only the formatted log information for the observation information group in a first storage area in the database.

13. The log management device according to claim 3, wherein the processor is configured to store the specified observation information in a second storage area in the database together with the formatted log information for the observation information group.

14. The log management device according to claim 4, wherein the processor is configured to store the observation information group in a third storage area in the database together with the formatted log information.

15. A log management method for causing a computer to execute a process, the process comprising:
obtaining observation information group including observation information that includes a request ID same each other that identifies a series of processing executed in response to a request among pieces of observation information related to processing executed in each microservice, the pieces of the observation information being collected from each microservice of a plurality of the microservices;
searching the obtained observation information group for error information that indicates occurrence of an error and warning information that indicates occurrence of an event to be a cause of the error; and
storing at least partial information of the observation information group in a database that serves as a storage location according to a search result of the error information and the warning information.

16. A non-transitory computer-readable recording medium storing a log management program for causing a computer to execute a process, the process comprising:
obtaining observation information group including observation information that includes a request ID same each other that identifies a series of processing executed in response to a request among pieces of observation information related to processing executed in each microservice, the pieces of the observation information being collected from each microservice of a plurality of the microservices;
searching the obtained observation information group for error information that indicates occurrence of an error and warning information that indicates occurrence of an event to be a cause of the error; and
storing at least partial information of the observation information group in a database that serves as a storage location according to a search result of the error information and the warning information.
